(19) United States
(12) Patent Application Publication
(10) Pub. No.: US 2026/0313554 A1
(43) Pub. Date: Oct. 8, 2026

(54) ADAPTIVE POWER-SAVING OPERATIONS FOR LOWER-LAYER TRIGGERED MOBILITY PROCEDURES

(71) Applicant: QUALCOMM Incorporated, San Diego, CA (US)

(72) Inventors: Ming YANG, San Diego, CA (US); Kausik RAY CHAUDHURI, San Diego, CA (US); Juan MONTOJO, San Diego, CA (US)

(21) Appl. No.: 19/558,310

(22) Filed: Mar. 5, 2026

Related U.S. Application Data
(60) Provisional application No. 63/784,591, filed on Apr. 7, 2025.

(51) Int. Cl. H04W 52/02; H04L 41/16; H04W 24/10

(52) U.S. Cl. CPC H04W 52/0235; H04L 41/16; H04W 24/10

(57) ABSTRACT

Various aspects of the present disclosure generally relate to wireless communication. In some aspects, a user equipment (UE) may transmit a capability message that indicates whether the UE is capable of temporarily disabling one or more UE power-saving operational modes in accordance with a mobility procedure. The UE may receive, from a network node, a message that temporarily disables at least one UE power-saving operational mode of the one or more UE power-saving operational modes in accordance with a Layer 1/Layer 2 or a Layer 3 mobility event that triggered a handover procedure. The UE may transmit a mobility-event measurement report in accordance with receiving the message. The UE may disable the at least one UE power-saving operational mode in accordance with transmitting the mobility-event measurement report. Numerous other aspects are described.

### CROSS-REFERENCE TO RELATED APPLICATION

This Patent Application claims priority to U.S. Provisional Patent Application No. 63/784,591, filed on Apr. 07, 2025, entitled “ADAPTIVE POWER-SAVING OPERATIONS FOR LOWER-LAYER TRIGGERED MOBILITY PROCEDURES,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with adaptive power-saving operations for lower-layer triggered mobility procedures.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

Wireless communication systems have been continuously evolving to meet the increasing demand for high-speed and reliable wireless services. These systems may utilize various mobility management techniques to support connection and handover between a user equipment (UE), and network nodes or serving cells. Mobility management may help maintain service continuity when a UE moves through different network coverage areas. These systems may also utilize various power-saving features to extend the battery life of UEs, such as connected mode discontinuous reception (DRX), a continuous DRX inactive mode, a physical downlink control channel (PDCCH) skipping mode, a sparse PDCCH monitoring mode, a disabled search space switching group (SSSG) mode, a light sleep mode, a deep sleep mode, or a power-saving mode, which may be designed to reduce power consumption by allowing UEs to enter sleep modes during periods of inactivity or to refrain from performing one or more actions while operating in the power-saving mode.

DRX includes specific cycles during which the UE alternates between operating in active and sleep states or modes. During the active periods, the UE may wake up to monitor a control channel for incoming data or control messages from a network node. If no message is received, the UE may re-enter the sleep state until a next scheduled wake-up time.

Mobility management techniques may include the use of lower layer triggered mobility techniques. These techniques may include physical layer or medium access control (MAC) layer triggers to initiate mobility procedures, such as handovers. Lower layer triggers may provide faster and more responsive mobility management compared to traditional higher layer methods. For example, signal measurements at the physical layer, such as reference signal received power (RSRP) or reference signal received quality (RSRQ), may be used to determine when a UE should transition from one cell to another. Similarly, MAC layer triggers may be used to report changes in signal conditions to the network node to support handover decision-making.

### SUMMARY

The systems, methods, and devices of this disclosure each have several innovative aspects, no single one of which is solely responsible for the desirable attributes disclosed herein.

Some aspects described herein relate to a user equipment (UE). The UE may include a processing system. The processing system may include one or more processors and one or more code-storing memories coupled with the one or more processors. The processing system may be configured to cause the UE to transmit a capability message that indicates whether the UE is capable of temporarily disabling one or more UE power-saving operational modes in accordance with a mobility procedure. The processing system may be configured to cause the UE to receive, from a network node, a message that temporarily disables at least one UE power-saving operational mode of the one or more UE power-saving operational modes in accordance with a Layer 1/Layer 2 (L1/L2) or a Layer 3 (L3) mobility event that triggered a handover procedure. The processing system may be configured to cause the UE to transmit a mobility-event measurement report in accordance with receiving the message. The processing system may be configured to cause the UE to disable the at least one UE power-saving operational mode in accordance with transmitting the mobility-event measurement report.

Some aspects described herein relate to a network node. The network node may include a processing system. The processing system may include one or more processors and one or more code-storing memories coupled with the one or more processors. The processing system may be configured to cause the network node to receive a capability message that indicates whether a UE is capable of temporarily disabling one or more UE power-saving operational modes in accordance with a mobility procedure. The processing system may be configured to cause the network node to transmit, to the UE, a message that temporarily disables at least one UE power-saving operational mode of the one or more UE power-saving operational modes in accordance with an L1/L2 or L3 mobility event that triggered an Handover procedure. The processing system may be configured to cause the network node to receive a mobility-event measurement report in accordance with transmitting the message.

Some aspects described herein relate to a method of wireless communication performed by a UE. The method may include transmitting a capability message that indicates whether the UE is capable of temporarily disabling one or more UE power-saving operational modes in accordance with a mobility procedure. The method may include receiving, from a network node, a message that temporarily disables at least one UE power-saving operational mode of the one or more UE power-saving operational modes in accordance with an L1/L2 or L3 mobility event that triggered an Handover procedure. The method may include transmitting a mobility-event measurement report in accordance with transmitting the message. The method may include disabling the at least one UE power-saving operational mode in accordance with transmitting the mobility-event measurement report.

Some aspects described herein relate to a method of wireless communication performed by a network node. The method may include receiving a capability message that indicates whether a UE is capable of temporarily disabling one or more UE power-saving operational modes in accordance with a mobility procedure. The method may include transmitting, to the UE, a message that temporarily disables at least one UE power-saving operational mode of the one or more UE power-saving operational modes in accordance with an L1/L2 or L3 mobility event that triggered an Handover procedure. The method may include receiving a mobility-event measurement report in accordance with receiving the message.

Some aspects described herein relate to a non-transitory computer-readable medium that stores a set of instructions for wireless communication by a UE. The set of instructions, when executed by one or more processors of the UE, may cause the UE to transmit a capability message that indicates whether the UE is capable of temporarily disabling one or more UE power-saving operational modes in accordance with a mobility procedure. The set of instructions, when executed by one or more processors of the UE, may cause the UE to receive, from a network node, a message that temporarily disables at least one UE power-saving operational mode of the one or more UE power-saving operational modes in accordance with an L1/L2 or L3 mobility event that triggered an Handover procedure. The set of instructions, when executed by one or more processors of the UE, may cause the UE to transmit a mobility-event measurement report in accordance with receiving the message. The set of instructions, when executed by one or more processors of the UE, may cause the UE to disable the at least one UE power-saving operational mode in accordance with transmitting the mobility-event measurement report.

Some aspects described herein relate to a non-transitory computer-readable medium that stores a set of instructions for wireless communication by a network node. The set of instructions, when executed by one or more processors of the network node, may cause the network node to receive a capability message that indicates whether a UE is capable of temporarily disabling one or more UE power-saving operational modes in accordance with a mobility procedure. The set of instructions, when executed by one or more processors of the network node, may cause the network node to transmit, to the UE, a message that temporarily disables at least one UE power-saving operational mode of the one or more UE power-saving operational modes in accordance with an L1/L2 or L3 mobility event that triggered an Handover procedure. The set of instructions, when executed by one or more processors of the network node, may cause the network node to receive a mobility-event measurement report in accordance with transmitting the message.

Some aspects described herein relate to an apparatus for wireless communication. The apparatus may include means for transmitting a capability message that indicates whether the UE is capable of temporarily disabling one or more UE power-saving operational modes in accordance with a mobility procedure. The apparatus may include means for receiving, from a network node, a message that temporarily disables at least one UE power-saving operational mode of the one or more UE power-saving operational modes in accordance with an L1/L2 or L3 mobility event that triggered an Handover procedure. The apparatus may include means for transmitting a mobility-event measurement report in accordance with receiving the message. The apparatus may include means for disabling the at least one UE power-saving operational mode in accordance with transmitting the mobility-event measurement report.

Some aspects described herein relate to an apparatus for wireless communication. The apparatus may include means for receiving a capability message that indicates whether a UE is capable of temporarily disabling one or more UE power-saving operational modes in accordance with a mobility procedure. The apparatus may include means for transmitting, to the UE, a message that temporarily disables at least one UE power-saving operational mode of the one or more UE power-saving operational modes in accordance with an L1/L2 or L3 mobility event that triggered an Handover procedure. The apparatus may include means for receiving a mobility-event measurement report in accordance with receiving the message.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antennas, RF-chains, power amplifiers, modulators, buffers, processor(s), interleavers, adders/summers, etc.). It is intended that innovations described herein may be practiced in a wide variety of devices, chip-level components, systems, distributed arrangements, end-user devices, etc., of varying sizes, shapes, and constitution.

### BRIEF DESCRIPTION OF THE DRAWINGS

FIG. 1 is a diagram illustrating an example of a wireless communication network.

FIG. 2 is a diagram illustrating an example of a Layer 1/Layer 2 triggered mobility procedure.

FIG. 3 is a diagram illustrating an example of a discontinuous reception (DRX) configuration.

FIG. 4 is a diagram illustrating an example associated with data interruption.

FIG. 5 is a diagram of an example associated with adaptive power-saving operations for lower-layer triggered mobility procedures.

FIG. 6 is a diagram illustrating an example associated with disabling connected mode DRX during handover procedures.

FIG. 7 is a diagram illustrating an example associated with connected mode DRX wake mode operations during handover procedures.

FIG. 8 is a diagram illustrating an example associated with disabling physical downlink control channel skipping during handover procedures.

FIG. 9 is a diagram illustrating an example process performed, for example, at a user equipment or an apparatus of a user equipment.

FIG. 10 is a diagram illustrating an example process performed, for example, at a network node or an apparatus of a network node.

FIG. 11 is a diagram of an example apparatus for wireless communication.

FIG. 12 is a diagram of an example apparatus for wireless communication.

### DETAILED DESCRIPTION

In some wireless communication systems, a user equipment (UE) may implement mobility procedures, such as handovers between serving cells or radio access technologies (RATs) to maintain a suitable connection during movement through a network. In some examples, mobility procedures may be triggered by lower layer signaling at the UE. A UE implementing power-saving features like connected mode discontinuous reception (C-DRX) may enter low power states during periods of inactivity, which may help conserve battery power at the UE.

During a handover, a UE may report to a network node that a neighboring cell may provide a better connection. Upon receiving this report, the network node may initiate handover preparation with the neighboring cell, which may then be considered a target cell. However, if the UE enters a low power state or C-DRX sleep mode while the network is preparing for the handover, the UE may become unresponsive to network commands, including the handover command. For example, the UE may fail to receive a handover command while operating in a low-power state and may delay or fail to perform handover to the target cell. This delay may lead to significant data interruption and service degradation, as the network node may wait for the UE to transition out of the power-saving state before completing the handover process.

The delays and service degradation caused by the lack of coordination between mobility procedures and power-saving mechanisms may be exacerbated by C-DRX cycle lengths observed in some wireless communication networks. For instance, with a C-DRX cycle of 320 milliseconds, a handover interruption may be extended by approximately half this time (around 160 milliseconds) for some data-supported calls. Such delays are not only undesirable for maintaining a seamless user experience but may cause failure for applications requiring low latency, such as ultra-reliable low-latency communication (URLLC) communications and extended reality (XR) applications. By leveraging lower layer triggers, wireless communication systems may achieve reduced latency and improved reliability in mobility management. This is particularly relevant for applications requiring low latency and high reliability, such as real-time video streaming, online gaming, and mission-critical communications.

Various aspects relate generally to enhancing coordination between UE power-saving modes and mobility procedures in wireless communication systems. For example, some aspects relate generally to maintaining at least some communications associated with an active state of the UE when mobility events that trigger handovers are reported, while also balancing power conservation considerations. Some aspects more specifically relate to a UE transmitting a capability message indicating whether the UE is capable of temporarily disabling one or more power-saving operational modes in accordance with a triggered mobility procedure. The UE may receive a radio resource control (RRC) message from a network node that temporarily disables at least one UE power-saving mode in association with a mobility event that triggers an Handover procedure. The UE may transmit a mobility-event measurement report in association with the received control message (e.g., in response to the RRC message, after disabling the power-saving operational mode).

In some aspects, the UE may initiate a timer after transmitting the mobility-event measurement report. In such aspects, the timer may be associated with a duration during which the power-saving mode is disabled. The UE power-saving operational mode may include various modes such as connected mode DRX mode, extended DRX mode, C-DRX inactive mode, physical downlink control channel (PDCCH) skipping mode, sparse PDCCH monitoring mode, disabled search space switching group (SSSG) mode, among other power-saving modes. In some aspects, the UE may disable the UE power-saving operational mode in accordance with an expiry of a timer that is initiated in accordance with transmitting the mobility-event measurement report. For example, the UE may delay disabling the power-saving mode. In some aspects, the UE may transmit a preference indication that indicates a duration for disabling the UE power-saving operational mode in accordance with one or more application latency conditions.

Particular aspects of the subject matter described in this disclosure may be implemented to realize one or more of the following technical benefits. By the UE temporarily disabling power-saving features during mobility events, such as handovers, the described techniques may support the reduction of data interruption and service degradation. By the UE monitoring for network commands during a suspended power-saving mode, the described techniques may be used to facilitate a more efficient handover process. By allowing the UE to communicate preferences regarding the temporary disabling of power-saving modes based on a technical assessment of application quality of service requirements, serving cell conditions, or algorithmic predictions, the described techniques may be used to strike a balance between maintaining network performance and decreasing mobility interruptions, leading to conservation of UE battery life and network resources.

By receiving technical capability indications from the UE and the network node transmitting control messages that adapt the UE power-saving mode operations to mobility procedures, the network node may increase the overall technical efficiency of the network by minimizing unnecessary power consumption by the UE and reducing latencies in handover execution. As wireless communication technology continues to advance, the integration and optimization of lower layer trigger mobility techniques, along with power-saving features like C-DRX, may be key for enhancing the overall efficiency and user experience in future communication systems.

5G New Radio (NR) may support enhanced mobile broadband (eMBB) access, Internet of Things (IoT) networks or reduced capability (RedCap) device deployments, URLLC applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, XR and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

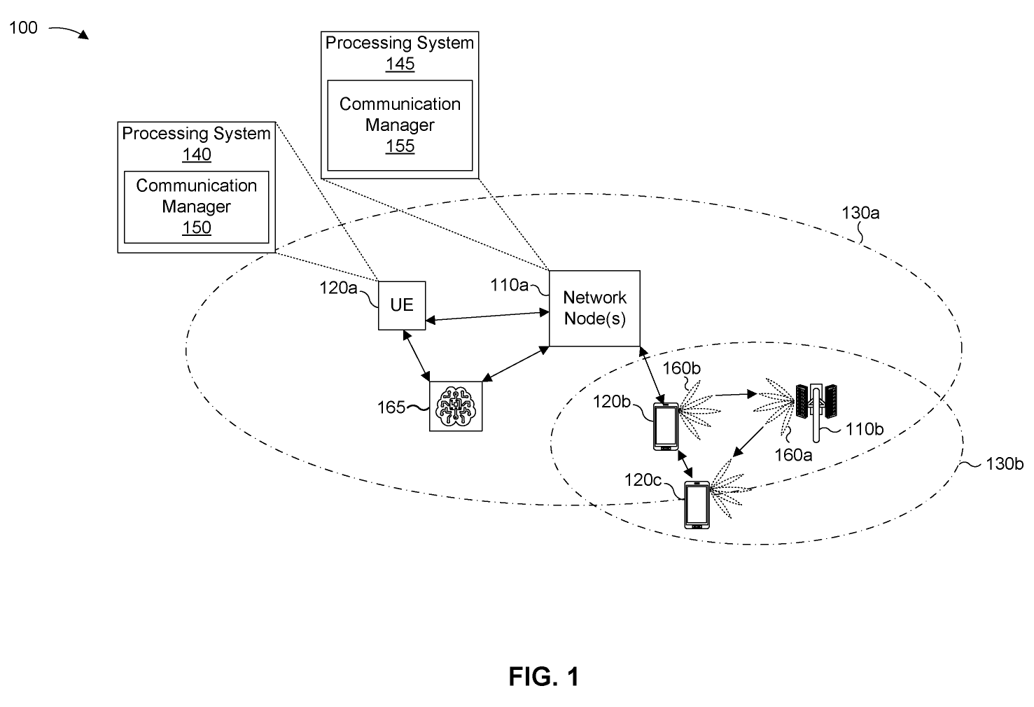

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as an RRC layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include PDCCHs, and downlink data channels may include physical downlink shared channels (PDSCHs). Control information or data communications may be transmitted on a PDCCH and PDSCH, respectively. For example, a PDCCH may carry DCI, while a PDSCH may carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH may carry UCI, while a PUSCH may carry a MAC-CE, an RRC message, or user data, among other examples. UCI may include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI may include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)- reference signal received power (RSRP) parameter, a received signal strength indicator (RSSI) parameter, a reference signal received quality (RSRQ) parameter, among other examples) which may be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

One enhancement for multi-beam operation at higher carrier frequencies is facilitation of efficient (for example, low latency and low overhead) downlink or uplink beam management operations to support Layer 1 or Layer 2 (L1/L2)-centric inter-cell mobility. L1/L2 signaling may be referred to as “lower layer” signaling. L1/L2 signaling may be used to activate or deactivate candidate cells in a set of cells configured for lower layer triggered mobility (LTM) or to provide reference signals for measurement by the UE 120, by which the UE 120 may select a candidate beam as a target beam for a lower layer handover operation. Accordingly, L1/L2-centric inter-cell mobility may enable a UE 120 to perform a cell switch via dynamic control signaling at lower layers (for example, DCI for L1 signaling or a MAC-CE for L2 signaling), rather than semi-static Layer 3 (L3) RRC signaling. Thus, L1/L2 centric inter-cell mobility may reduce latency, reduce overhead, or otherwise increase efficiency of the cell switch.

In some aspects, the UE 120 may include a communication manager 150. As described in more detail elsewhere herein, the communication manager 150 may transmit a capability message that indicates whether the UE 120 is capable of temporarily disabling one or more UE power-saving operational modes in accordance with a mobility procedure; receive, from the network node 110, a message that temporarily disables at least one UE power-saving operational mode of the one or more UE power-saving operational modes in accordance with a Layer 1/Layer 2 or a Layer 3 mobility event that triggered a handover procedure; transmit a mobility-event measurement report in accordance with receiving the message; and disable the at least one UE power-saving operational mode in accordance with transmitting the mobility-event measurement report. Additionally, or alternatively, the communication manager 150 may perform one or more other operations described herein.

In some aspects, the network node 110 may include a communication manager 155. As described in more detail elsewhere herein, the communication manager 155 may receive a capability message that indicates whether the UE is capable of temporarily disabling one or more UE power-saving operational modes in accordance with a mobility procedure; transmit, to the UE 120, a message that temporarily disables at least one UE power-saving operational mode of the one or more UE power-saving operational modes in accordance with an L1/L2 or L3 mobility event that triggered an Handover procedure; and receive a mobility-event measurement report in accordance with transmitting the message. Additionally, or alternatively, the communication manager 155 may perform one or more other operations described herein.

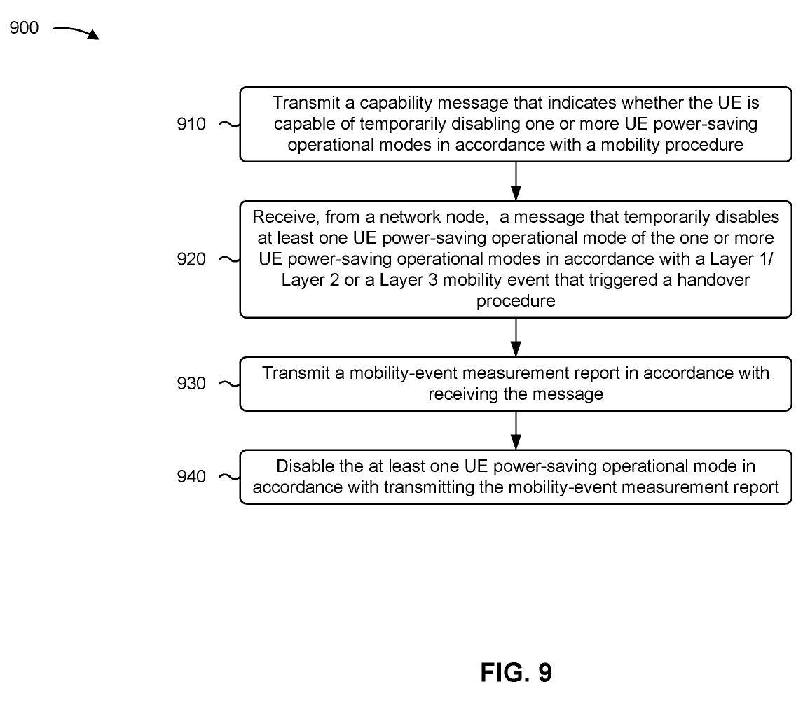

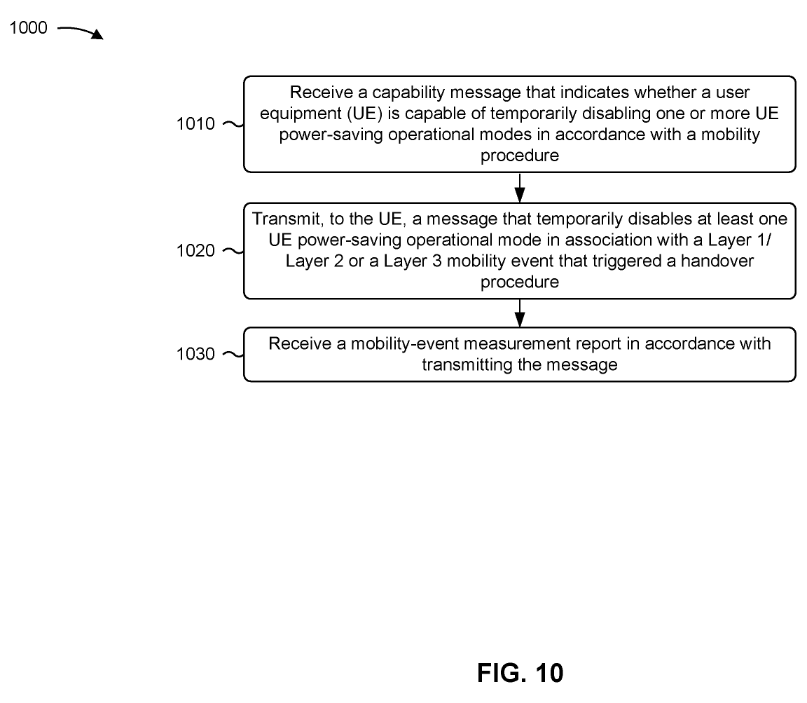

The network node 110, the processing system 145 of the network node 110, the UE 120, the processing system 140 of the UE 120, or any other component(s) of FIG. 1 may implement one or more techniques or perform one or more operations associated with adaptive power-saving operations for LTM procedures, as described in more detail elsewhere herein. For example, the processing system 145 of the network node 110, or the processing system 140 of the UE 120 may perform or direct operations of, for example, process 900 of FIG. 9, process 1000 of FIG. 10, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 900 of FIG. 9, process 1000 of FIG. 10, or other processes as described herein. In some examples, executing instructions may include running the instructions, converting the instructions, compiling the instructions, or interpreting the instructions, among other examples.

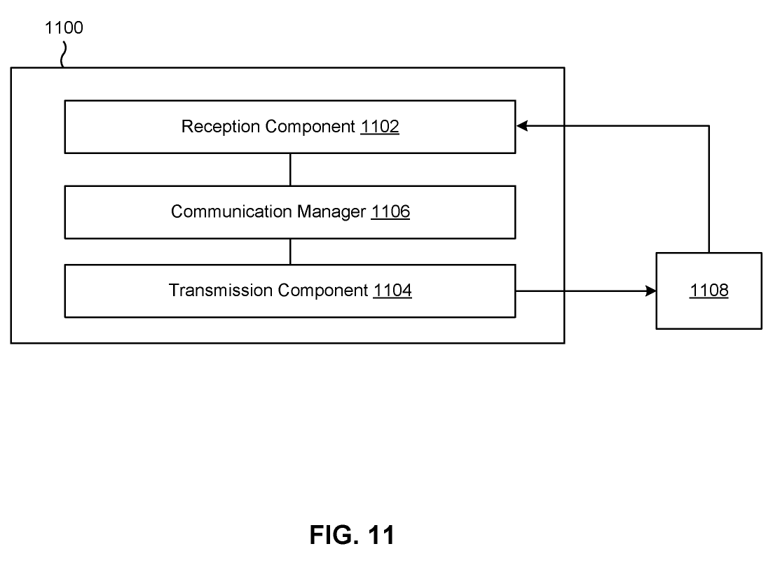

In some aspects, the UE 120 includes means for transmitting a capability message that indicates whether the UE 120 is capable of temporarily disabling one or more UE power-saving operational modes in accordance with a mobility procedure; means for receiving, from the network node 110, a message that temporarily disables at least one UE power-saving operational mode of the one or more UE power-saving operational modes in accordance with an L1/L2 or L3 mobility event that triggered an Handover procedure; means for transmitting a mobility-event measurement report in accordance with receiving the message; or means for disabling the at least one UE power-saving operational mode in accordance with transmitting the mobility-event measurement report. The means for the UE 120 to perform operations described herein may include, for example, one or more of communication manager 150, processing system 140, a radio, one or more RF chains, one or more transceivers, one or more antennas, one or more modems, a reception component (for example, reception component 1102 depicted and described in connection with FIG. 11), or a transmission component (for example, transmission component 1104 depicted and described in connection with FIG. 11), among other examples.

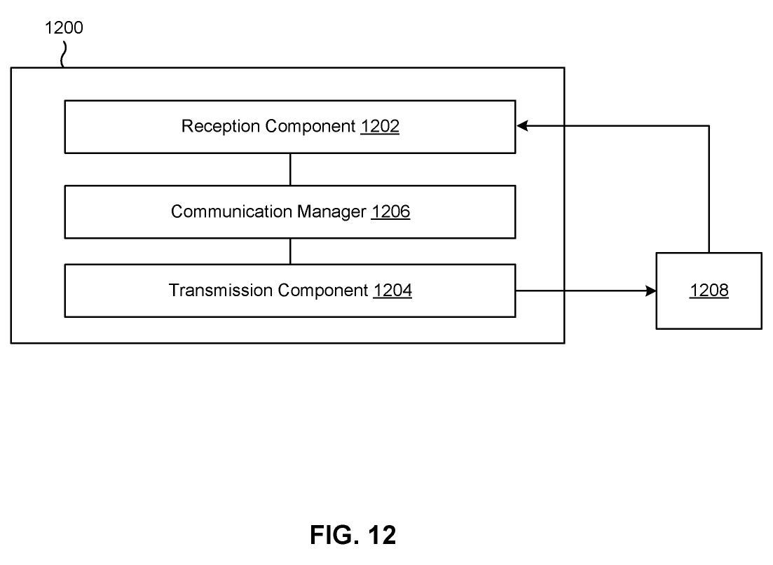

In some aspects, the network node 110 includes means for receiving a capability message that indicates whether the UE 120 is capable of temporarily disabling one or more UE power-saving operational modes in accordance with a mobility procedure; means for transmitting, to the UE 120, a message that temporarily disables at least one UE power-saving operational mode of the one or more UE power-saving operational modes in accordance with an L1/L2 or L3 mobility event that triggered an Handover procedure; or means for receiving a mobility-event measurement report in accordance with transmitting the message. The means for the network node 110 to perform operations described herein may include, for example, one or more of communication manager 155, processing system 145, a radio, one or more RF chains, one or more transceivers, one or more antennas, one or more modems, a reception component (for example, reception component 1202 depicted and described in connection with FIG. 12), or a transmission component (for example, transmission component 1204 depicted and described in connection with FIG. 12), among other examples.

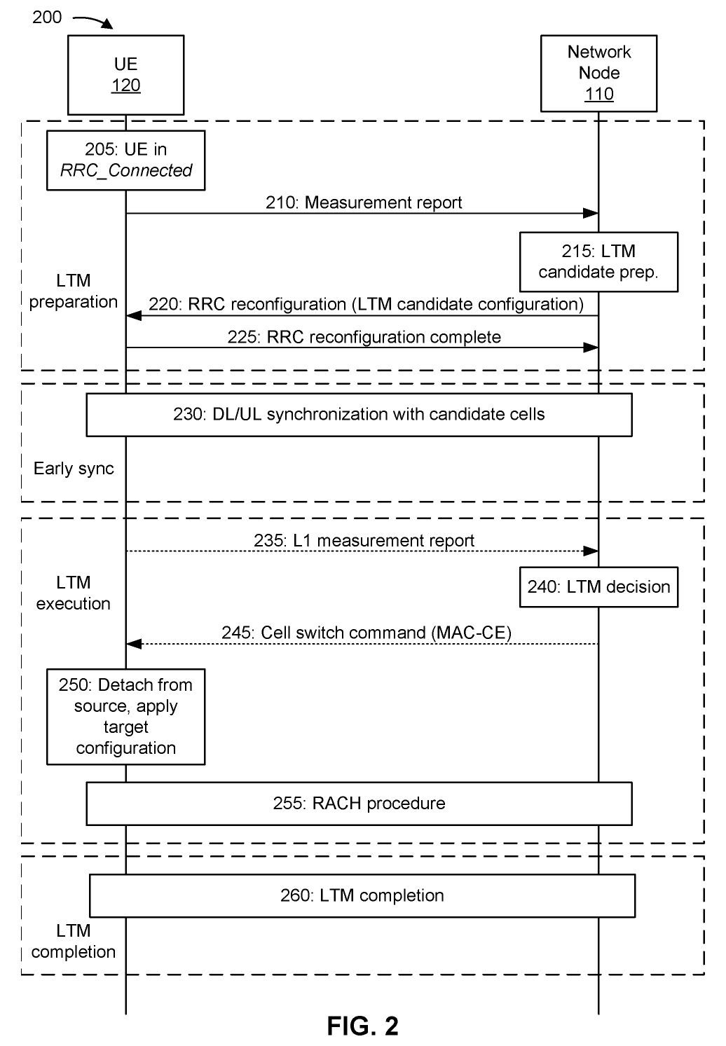

FIG. 2 is a diagram illustrating an example 200 of a Layer 1/Layer 2 (L1/L2) triggered mobility (LTM) procedure.

In some examples, a network node 110 may instruct a UE 120 to change serving cells, such as when the UE 120 moves away from coverage of a current serving cell (sometimes referred to as a source cell) and towards coverage of a neighboring cell (sometimes referred to as a target cell). In some cases, the network node 110 may instruct the UE 120 to change cells using a layer 3 (L3) handover procedure. An L3 handover procedure may include the network node 110 transmitting, to the UE 120, an RRC reconfiguration message indicating that the UE 120 should perform a handover procedure (e.g., an Handover procedure) to a target cell, which may be transmitted in response to the UE 120 providing the network node 110 with an L3 measurement report indicating signal strength measurements associated with various cells (e.g., measurements associated with the source cell and one or more neighboring cells). In response to receiving the RRC reconfiguration message, the UE 120 may communicate with the source cell and the target cell to detach from the source cell and connect to the target cell (e.g., the UE 120 may establish an RRC connection with the target cell). Once handover is complete, the target cell may communicate with a user plane function (UPF) of a core network to instruct the UPF to switch a user plane path of the UE 120 from the source cell to the target cell. The target cell may also communicate with the source cell to indicate that handover is complete and that the source cell may be released.

L3 handover procedures may be associated with high latency and high overhead due to the multiple RRC reconfiguration messages or other L3 signaling and operations used to perform the handover procedures. Accordingly, in some examples, a UE 120 may be configured to perform a lower-layer (e.g., L1 or L2) handover procedure, sometimes referred to an LTM procedure, such as the example 200 LTM procedure shown in FIG. 2. As shown in FIG. 2, the LTM procedure may include four phases: an LTM preparation phase, an early synchronization phase (shown as “early sync” in FIG. 2), an LTM execution phase, or an LTM completion phase.

During the LTM preparation phase, and as shown by reference number 205, the UE 120 may be in an RRC connected state (sometimes referred to as RRC_Connected) with a source cell. As shown by reference number 210, the UE 120 may transmit, and the network node 110 may receive, a measurement report (sometimes referred to as a MeasurementReport), which may be an L3 measurement report. The measurement report may indicate signal strength measurements (e.g., RSRP, RSSI, RSRQ, or CQI) or similar measurements associated with the source cell or one or more neighboring cells. In some examples, based at least in part on the measurement report or other information, the network node 110 may decide to use LTM, and thus, as shown by reference number 215, the network node 110 may initiate LTM candidate preparation.

As shown by reference number 220, the network node 110 may transmit, and the UE 120 may receive, an RRC reconfiguration message (sometimes referred to as an RRCReconfiguration message), which may include an LTM candidate configuration. More particularly, the RRC reconfiguration message may indicate a configuration of one or more LTM candidate target cells, which may be candidate cells to become a serving cell of the UE or cells for which the UE 120 may later be triggered to perform an LTM procedure. As shown by reference number 225, the UE 120 may store the configuration of the one or more LTM candidate cell configurations and, in response, may transmit, to the network node 110, an RRC reconfiguration complete message (sometimes referred to as an RRCReconfigurationComplete message).

During the early synchronization phase, and as shown by reference number 230, the UE 120 may optionally perform downlink/uplink synchronization with the candidate cells associated with the one or more LTM candidate cell configurations. For example, the UE 120 may perform downlink synchronization and timing advance acquisition with the one or more candidate target cells prior to receiving an LTM switch command (which is described in more detail below in connection with reference number 225). In some aspects, performing the early synchronization with the one or more candidate cells may reduce latency associated with performing a random access channel (RACH) procedure later in the LTM procedure, which is described in more detail below in connection with reference number 255.

During the LTM execution phase, and as shown by reference number 235, the UE 120 may perform L1 measurements on the configured LTM candidate target cells, and thus may transmit, to the network node 110, lower-layer (e.g., L1) measurement reports. As shown by reference number 240, based at least in part on the lower-layer measurement reports, the network node 110 may decide to execute an LTM cell switch to a target cell. Accordingly, as shown by reference number 245, the network node 110 may transmit, and the UE 120 may receive, a MAC-CE or similar message triggering an LTM cell switch (the MAC-CE or similar message is sometimes referred to herein as a cell switch command). The cell switch command may include an indication of a candidate configuration index associated with the target cell. As shown by reference number 250, based at least in part on receiving the cell switch command, the UE 120 may switch to the configuration of the LTM candidate target cell (e.g., the UE 120 may detach from the source cell and apply the target cell configuration). Moreover, as shown by reference number 255, the UE 120 may perform a RACH procedure towards the target cell, such as when a timing advance associated with the target cell is not available (e.g., in examples in which the UE 120 did not perform the early synchronization as described above in connection with reference number 230).

During the LTM completion phase, and as shown by reference number 260, the UE 120 may indicate successful completion of the LTM cell switch towards the target cell. In this way, cell switch to a target cell may be performed using less overhead than for an L3 handover procedure or a cell switch to a target cell may be associated with reduced latency as compared to L3 handover procedure.

During a handover, the UE 120 may report to the network node 110 that a neighboring cell may provide a better connection. Upon receiving this report, the network node may initiate handover preparation with the neighboring cell, which may then be considered a target cell. However, if the UE 120 enters a low power state or C-DRX sleep mode while the network 110 is preparing for the handover, described in connection with reference number 215, the UE 120 may become unresponsive to network commands, and may fail to receive the RRC reconfiguration message described in connection with reference number 220 or the cell switch command described in connection with reference number 245, which may delay or cause a failure of the handover procedure. This delay may lead to significant data interruption and service degradation, as the network node 110 may wait for the UE 120 to transition out of the power-saving state before completing the handover process. However, by leveraging lower layer triggers, wireless communication systems may achieve reduced latency and improved reliability in mobility management. This may be particularly relevant for applications requiring low latency and high reliability, such as real-time video streaming, online gaming, and mission-critical communications.

As indicated above, FIG. 2 is provided as an example. Other examples may differ from what is described with respect to FIG. 2.

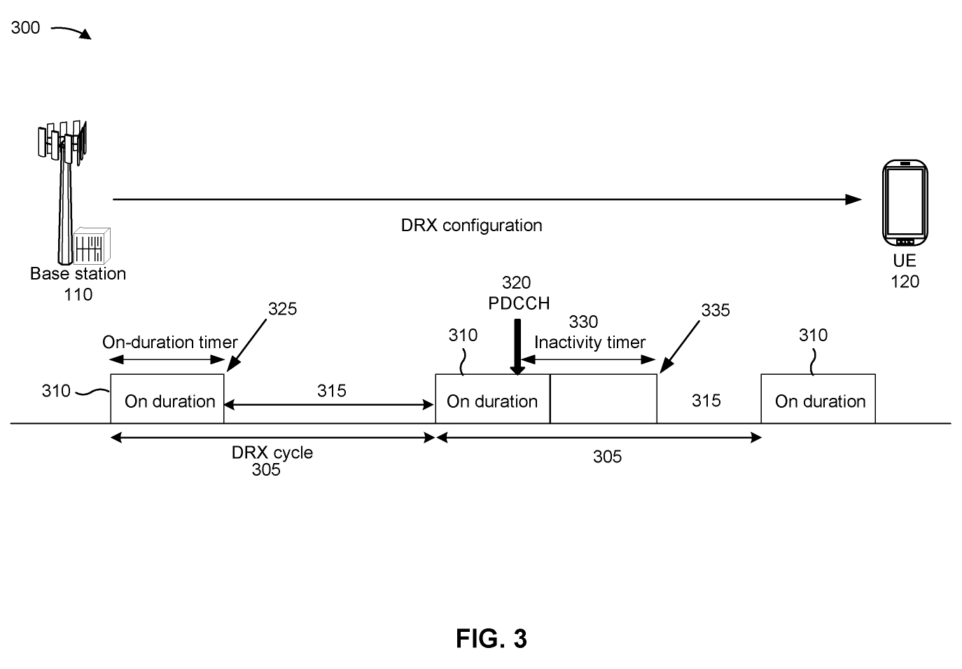

FIG. 3 is a diagram illustrating an example 300 of a DRX configuration.

As shown in FIG. 3, a network node 110 may transmit a DRX configuration to a UE 120 to configure a DRX cycle 305 for the UE 120. A DRX cycle 305 may include a DRX on duration 310 (e.g., during which a UE 120 is awake or in an active state) and an opportunity to enter a DRX sleep state 315. As used herein, the time during which the UE 120 is configured to be in an active state during the DRX on duration 310 may be referred to as an active time, and the time during which the UE 120 is configured to be in the DRX sleep state 315 may be referred to as an inactive time. As described below, the UE 120 may monitor a PDCCH during the active time, and may refrain from monitoring the PDCCH during the inactive time.

During the DRX on duration 310 (e.g., the active time), the UE 120 may monitor a downlink control channel (e.g., a PDCCH), as shown by reference number 320. 320. For example, the UE 120 may monitor the PDCCH for DCI pertaining to the UE 120. If the UE 120 does not detect or successfully decode any PDCCH communications intended for the UE 120 during the DRX on duration 310, then the UE 120 may enter the sleep state 315 (e.g., for the inactive time) at the end of the DRX on duration 310, as shown by reference number 325. In this way, the UE 120 may conserve battery power and reduce power consumption. As shown, the DRX cycle 305 may repeat with a configured periodicity according to the DRX configuration.

If the UE 120 detects or successfully decodes a PDCCH communication intended for the UE 120, then the UE 120 may remain in an active state (e.g., awake) for the duration of a DRX inactivity timer 330 (e.g., which may extend the active time). The UE 120 may start the DRX inactivity timer 330 at a time at which the PDCCH communication is received (e.g., in a transmission time interval (TTI) in which the PDCCH communication is received, such as a slot or a subframe). The UE 120 may remain in the active state until the DRX inactivity timer 330 expires, at which time the UE 120 may enter the sleep state 315 (e.g., for the inactive time), as shown by reference number 335. During the duration of the DRX inactivity timer 330, the UE 120 may continue to monitor for PDCCH communications, may obtain a downlink data communication (e.g., on a downlink data channel, such as a PDSCH) scheduled by the PDCCH communication, or may prepare or transmit an uplink communication (e.g., on a PUSCH) scheduled by the PDCCH communication. The UE 120 may restart the DRX inactivity timer 330 after each detection of a PDCCH communication for the UE 120 for an initial transmission (e.g., but not for a retransmission). By operating in this manner, the UE 120 may conserve battery power and reduce power consumption by entering the sleep state 315.

As described with respect to FIG. 2, there may be a lack of coordination between power saving modes, such as DRX and specifically C-DRX in which power saving considerations are prioritized over user experience and mobility-triggered handover procedures such that mobility-triggered handover procedures may be negatively affected by power-saving operations. The delays and service degradation caused by the lack of coordination between mobility procedures and power-saving mechanisms may be exacerbated by C-DRX cycle lengths observed in some wireless communication networks. For instance, with a C-DRX cycle of 320 milliseconds, a handover interruption may be extended by approximately half this time (around 160 milliseconds) for some data-supported calls. Such delays are not only undesirable for maintaining a seamless user experience but may cause failure for applications requiring low latency, such as URLLC communications and XR applications.

As indicated above, FIG. 3 is provided as an example. Other examples may differ from what is described with respect to FIG. 3.

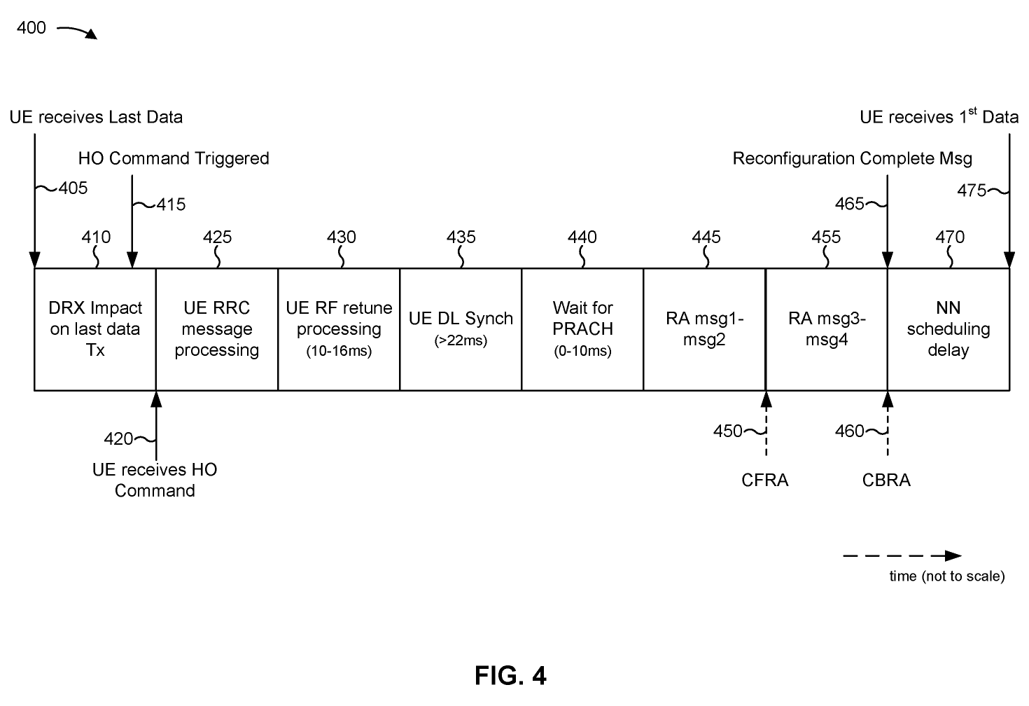

FIG. 4 is a diagram illustrating an example 400 associated with data interruption caused by a lack of coordination between power-saving operational modes of a UE and LTM procedures.

As shown by reference number 405, a UE may receive the last data transmission before the handover command is triggered. For example, the UE may experience the impact of DRX on the last data transmission, as indicated by reference number 410. DRX is a mechanism that allows the UE to enter a low power state during periods of inactivity to conserve battery life. For example, as shown by reference number 410, the UE may enter a DRX mode or may refrain from monitoring for one or more data or control message in association with entering the DRX mode in response to receiving the last data transmission. In some aspects, the UE may receive the final data packet described in connection with reference number 405 before receiving the handover command, as indicated by reference number 420.

As shown by reference number 415, a handover (HO) command may be triggered by one or more mobility considerations of the UE (for example, a HO command may be triggered by L1 or L2 signaling or indication) or the network node associated with the serving cell of the UE, and as shown by reference number 420, the network node may transmit, and the UE may receive the HO command, for example, via an RRC message. As shown by reference number 425, after receiving the HO command, the UE may process the RRC message. The RRC message processing may include the UE interpreting the HO command and preparing for the handover procedure.

The time between the UE receiving the last data packet/entering the DRX mode and the HO command being triggered may be dependent on the monitoring cycles of the DRX mode. For example, when the serving cell receives an HO preparation ACK from the target cell after the UE transmits the measurement report, there may be a high likelihood that the UE is already transitioning into C-DRX sleep due to the expiration of the C-DRX inactivity timer. As a result, the source cell may delay transmitting Layer 3 or L1 handover commands as UE may refrain from monitoring for PDCCH communications during a C-DRX sleep cycle and thus, may not recover the handover command from network node.

As shown by reference number 430, the UE may perform RF retune processing, which may take between 10 to 16 milliseconds. This step may involve the UE adjusting one or more radio frequency settings to synchronize with the target cell. In some aspects, the UE may tune the one or more radio frequency settings to synchronize with the target cell.

As indicated by reference number 435, the UE may perform downlink synchronization with the target cell, which may take more than 22 milliseconds. This synchronization may increase the likelihood that the UE is properly aligned with the timing of communications with the target cell.

As shown by reference number 440, the UE may wait for the PRACH procedure to complete, which may take between 0 to 10 milliseconds. The PRACH procedure is used by the UE to establish initial contact with the target cell and to request resources for communication. In some aspects, the UE completes the PRACH procedure, which involves initial contact with the target cell, typically requiring 0-10 milliseconds.

Once the PRACH procedure is complete, as indicated by reference number 445, the UE may exchange one or more random access (RA) messages with the network node, for example, including mag1 or msg2. In some examples, as shown by reference number 450, these messages may be part of a contention-free random access (CFRA) procedure.

As further shown by reference number 455, the UE may exchange an RA message 3 or RA message 4 with the network node. In some examples, these messages may be part of a contention-based random access (CBRA) procedure. This step involves the UE resolving any contention issues and finalizing the resource allocation for communication with the target cell. In some aspects, the UE continues with the CBRA procedure, exchanging RA message 3 and RA message 4 to resolve contention and finalize resource allocation, as shown by reference number 460. Additionally, or alternatively, to resolve contention and complete resource allocation, the UE exchanges RA message 3 and RA message 4 during the contention-based random access procedure, as shown by reference number 460.

As shown by reference number 465, the reconfiguration of the UE may be complete. For example, after the RA message exchange described in connection with reference numbers 445-465, the RRC reconfiguration of the UE with the serving cell may be complete. However, there may be a delay before the network node may schedule communications between the UE and the serving cell. For example, as shown by reference number 470, there may be an additional delay associated with the network node scheduling communication resources for the UE and the target cell.

As further shown by reference number 475, the UE may receive the first data transmission from the target cell. This step marks the completion of the handover procedure.

As shown, there may be a significant amount of time between a UE triggering an LTM mobility procedure and completion of the handover procedure which may be exacerbated by unsynchronized DRX cycles occurring during such a procedure. For example, a typical C-DRX cycle may be 320ms for packet-switched data call, and 40ms for voice over NR call, and in such examples, HO interruption may be increased by as much as or even more than half of C-DRX cycle, thus potentially increasing the handover procedure by 160ms for a packet-switched data call, and 20ms for a voice over NR call.

As indicated above, FIG. 4 is provided as an example. Other examples may differ from what is described with respect to FIG. 4.

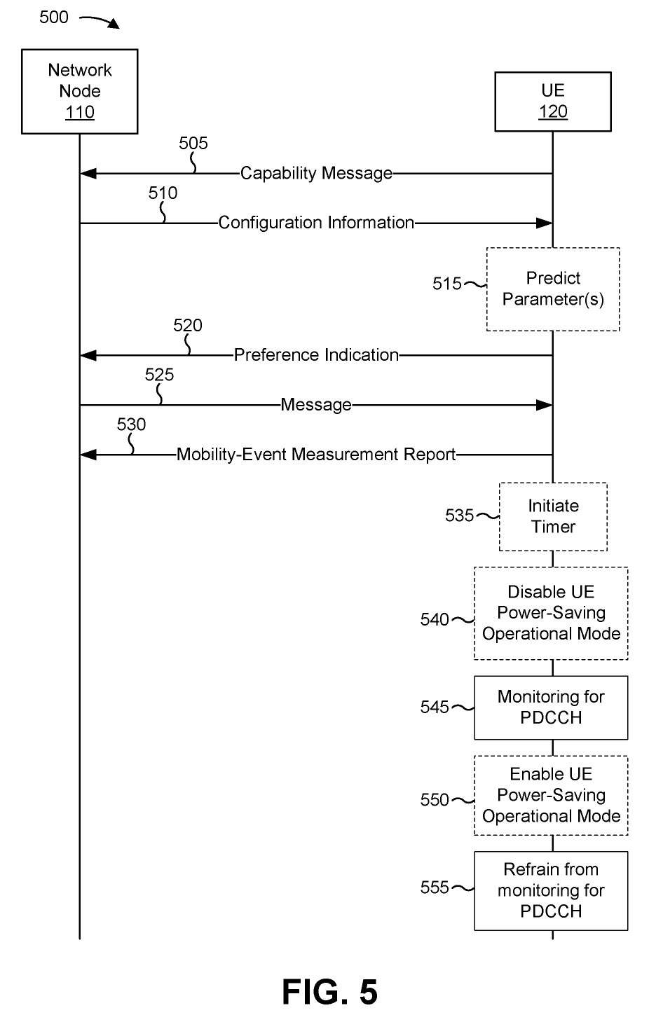

FIG. 5 is a diagram of an example 500 associated with adaptive power-saving operations for LTM procedures. As shown in FIG. 5, a network node 110 (e.g., a base station, a CU, a DU, or an RU) may communicate with a UE 120. In some aspects, the network node 110 and the UE 120 may be part of a wireless network (e.g., the wireless communication network 100). The UE 120 and the network node 110 may have established a wireless connection prior to operations shown in FIG. 5.

In some aspects, as shown by reference number 505, the UE 120 may transmit capability information. The capability information may be included in a capability report. The UE 120 may transmit the capability information via an uplink communication, a sidelink communication, a unicast communication, a broadcast communication, a UE assistance information (UAI) communication, a UCI communication, a sidelink control information (SCI) communication, a MAC-CE communication, an RRC communication, a PUCCH, a PUSCH, a physical sidelink control channel (PSCCH), or a physical sidelink shared channel (PSSCH), among other examples. The capability information may indicate one or more parameters associated with respective capabilities of the UE 120. The one or more parameters may be indicated via respective information elements (IEs) included in a capability report.

The capability information may indicate whether the UE 120 supports a feature or one or more parameters related to the feature. For example, the capability information may indicate a capability or parameter for coordinating UE power-saving modes and mobility procedures. As another example, the capability information may indicate a capability or parameter for adaptive C-DRX for handover data interruption reduction. One or more operations described herein may be based on capability information. For example, the UE 120 may perform a communication in accordance with the capability information, or may receive configuration information that is in accordance with the capability information. In some aspects, the capability information may indicate a quantity of C-DRX cycles or a duration of time for which the UE is capable of disabling C-DRX. As another example, the capability information may indicate a capability or parameter for supporting wake-up mode operations for handover data interruption reduction. One or more operations described herein may be based on capability information. For example, the UE 120 may perform a communication in accordance with the capability information, or may receive configuration information that is in accordance with the capability information. In some aspects, the capability information may indicate a duration of time for which the UE is capable of maintaining a wake-up mode. As another example, the capability information may indicate a capability or parameter for disabling PDCCH skipping for handover data interruption reduction. One or more operations described herein may be based on capability information. For example, the UE 120 may perform a communication in accordance with the capability information, or may receive configuration information that is in accordance with the capability information. In some aspects, the capability information may indicate a duration of time for which the UE is capable of disabling PDCCH skipping.

In some aspects, the capability message may indicate whether the UE is capable of temporarily disabling one or more UE power-saving operation modes in accordance with a mobility procedure (e.g., during a triggered mobility procedure, in preparation for a mobility procedure, among other examples). In some aspects, the one or more UE power-saving operational modes include at least one of a connected mode discontinuous reception (DRX) mode, an extended DRX mode, a continuous DRX inactive mode, a physical downlink control channel (PDCCH) skipping mode, a sparse PDCCH monitoring mode, a minimized grant-to-resource allocation gap mode, a disabled SSSG mode, UE light sleep mode, UE sleep mode, or a power-saving mode. In some aspects, the minimized grant-to-resource allocation gap mode may include a crossing slot with a minimal uplink or downlink schedule interval. For example, the network node may indicate a minimal time gap between communicating a resource grant and data communication, and the UE 120 may enable or enter a sleep mode of operation during the time gap to conserve UE power. When entering the sleep mode during the time gap is disabled, the UE 120 may receive an Handover message earlier, for example, especially when a serving cell signal strength, or quality, or both fall below a threshold.

As shown by reference number 510, the network node 110 may transmit, and the UE 120 may receive, configuration information. In some aspects, the UE 120 may receive the configuration information via one or more of system information signaling (e.g., a master information block (MIB) or a system information block (SIB), among other examples), RRC signaling, MAC signaling (e.g., one or more MAC-CEs), or physical layer signaling (e.g., DCI), among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may select a candidate configuration or communication parameter from the one or more candidate configurations or communication parameters. In some aspects, the subsequent indication may include a dynamic indication, such as one or more MAC CEs or one or more DCI messages, among other examples.

In some aspects, the configuration information may include an indication of a selection of one or more configuration parameters (e.g., a selection of the one or more configuration parameters already known to the UE 120 or previously indicated by the network node or other network device), or explicit configuration information for the UE 120 to use to configure the UE 120, among other examples.

In some examples, the configuration information may not be expressly signaled to the UE 120. For example, in some aspects, the configuration information may at least partially be defined by a wireless communication standard, such as the 3GPP. In such examples, the network node 110 may not explicitly indicate such configuration information to the UE 120. For example, the UE 120 may optionally obtain at least a portion of the configuration information from a configuration stored by the UE 120 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some aspects, the configuration information may indicate a quantity of time or a duration of cycles for disabling C-DRX, disabling PDCCH skipping, or maintaining wake-up mode operations. In some aspects, the configuration information may indicate one or more timers or delays for offsetting implementation of adaptive power-saving techniques from a trigger.

The UE 120 may configure itself based at least in part on the configuration information. In some aspects, the UE 120 may be configured to perform one or more operations described herein based at least in part on the configuration information.

As shown by reference number 515, the UE 120 may predict one or more parameters associated with application performance or handover procedures. For example, the UE 120 may use historical data or a machine learning algorithm to predict the duration or impact of temporarily disabling the UE power-saving operational mode. In some aspects, the UE 120 may utilize historical data or predictive algorithms to forecast the impact of disabling a power-saving mode on application performance or handover success. For example, the UE 120 may analyze past mobility events to predict future outcomes. Additionally, or alternatively, predictive models may include machine learning algorithms such as decision trees, neural networks, or support vector machines to assess the potential effects on network connectivity and user experience. For example, a neural network model may predict the impact of power-saving mode adjustments based on various input parameters. Additionally, or alternatively, the UE 120 may utilize machine learning models, such as linear regression or logistic regression, to predict the impact on application performance during mobility procedures. For example, logistic regression may be used to predict the likelihood of successful handover events. These predictive models help optimize the UE performance during handover events.

As further shown by reference number 520, the UE 120 may transmit a preference indication to the network node 110. For example, the UE 120 may indicate a preference for disabling the power-saving operational mode, including the preferred duration based on application latency conditions or QoS parameters. In some aspects, the UE 120 may send a preference message to the network node 110 indicating one or more power-saving mode settings based on current application needs or QoS requirements. For example, the UE 120 may indicate a preference to disable power-saving modes during high-latency applications such as video streaming. Additionally, or alternatively, the preference indication may include preferred durations for disabling power-saving modes, for example, to accommodate latency-sensitive applications. As an example, the UE 120 may indicate a preference for disabling power-saving modes for a duration during a video call. Additionally, or alternatively, the indication may also reflect preferences based on current serving cell conditions and predicted network performance during mobility events. For example, the UE 120 may indicate a preference to disable power-saving modes based on the signal strength of the serving cell. This allows the network node 110 to tailor the power-saving mode management according to the UE operating environment and service requirements.

As shown by reference number 525, the network node 110 may transmit, and the UE 120 may receive a message, such as an RRC message or a MAC-CE message. The message may temporarily disable the at least one UE power-saving operational mode in association with an L1/L2 or L3 mobility event that triggered an Handover procedure or may indicate that the UE 120 is to temporarily disable the at least one UE power-saving operational mode. In some aspects, the UE 120 may be configured or enabled with more than one power-saving feature and the message may disable more than one UE power-saving features or operational modes. In some aspects, the UE 120 may receive an RRC message or a MAC-CE message from the network node 110, instructing the UE 120 to temporarily disable a power-saving mode in preparation for an imminent handover. For example, the message may indicate that the UE 120 is to disable C-DRX or another power-saving mode as described herein, during the handover process. Additionally, or alternatively, the message may include details on the expected duration of the handover procedure and the specific power-saving modes to be disabled. For example, the message may specify that the handover is expected to last for a duration of time, and the UE 120 may disable the power-saving mode during this time. Additionally, or alternatively, the message received by the UE 120 may indicate an expected duration for performing the handover procedure with a target cell. For example, the message may specify that the handover to the target cell is expected to last for a duration of time. This information helps the UE 120 remain responsive during the handover process, by disabling features that may prevent the UE 120 from receiving or responding to handover messages.

In some aspects, the message may indicate a serving cell signal strength threshold or a serving cell signal quality threshold that when satisfied may trigger the UE 120 to disable (e.g., or not disable when not satisfied) the at least one UE power-saving operational modes.

As shown by reference number 530, the UE 120 may transmit a mobility-event measurement report in response to receiving the message. This report may include indications of conditions associated with the L1/L2 or L3 mobility event, such as cell conditions or radio frequency conditions. In some aspects, the UE 120 may send a detailed measurement report to the network node 110, including data on current cell conditions, signal strength, and radio frequency metrics. For example, the measurement report may include the signal strength of the current cell and the target cell. Additionally, or alternatively, the report may also include information on radio access technology conditions and other relevant parameters to assist the network node in making informed handover decisions. For example, the report may include details on the radio access technology being used and any interference metrics. Additionally, or alternatively, the UE 120 may include cell conditions, radio frequency conditions, and radio access technology conditions in the mobility-event measurement report. For example, the report may provide a comprehensive overview of the current cell conditions, including signal quality and interference levels. This comprehensive reporting assists the network node 110 in making informed decisions regarding the handover process by providing information that is relevant to the handover procedure.

As shown by reference number 535, the UE 120 may initiate or activate a timer after transmitting the mobility-event measurement report. The timer may be associated with the duration during which the UE power-saving operational mode is disabled. In some aspects, the UE 120 may start a timer after transmitting the mobility-event measurement report, initiating the period during which power-saving modes will be disabled. Additionally, or alternatively, the timer may also be associated with a specific number of cycles for which the power-saving modes are to be disabled. In some aspects, some aspects, the timer may be initiated when the UE disables the power saving mode, described in connection with reference number 540. In some aspects, the UE 120 may initiate a timer for delaying disabling of the power-saving mode. For example, the UE 120 may disable the power-saving mode after expiry of the timer.

As further shown by reference number 540, the UE 120 may (e.g., temporarily) disable the power-saving operational mode. For example, the UE 120 may refrain from entering or may disable a low power state, such as C-DRX, or PDCCH skipping mode, or may remain in a wake cycle of a DRX mode, during the duration indicated by the timer or according to an indicated quantity of power-saving mode cycles.. In some aspects, the UE 120 may disable the power-saving modes, such as C-DRX, light sleep, or deep sleep, for the duration specified by the timer or number of cycles. For example, the UE 120 may disable C-DRX for the duration indicated by the timer. In some aspects, the duration may be associated with one or more serving cell signal strength or signal quality conditions. Additionally, or alternatively, the UE may extend the active periods of these modes or adjust their inactive settings to maintain responsiveness during the handover. For example, the UE 120 may extend the active period or wake cycle of C-DRX to may increase the likelihood the UE 120 remains responsive. Additionally, or alternatively, the UE 120 may disable a power-saving operational mode by extending the C-DRX on duration or adjusting one or more inactive timer settings. For example, the UE 120 may adjust the inactive timer settings to maintain a higher level of activity during the handover. This adjustment helps maintain responsiveness during mobility events and may prevent unnecessary delay cause by missed communications. In some aspects, the UE 120 may refrain from entering a sleep mode during a period between receiving a physical downlink control channel message and communicating a data channel message, in accordance with disabling the at least one UE power-saving operational mode.

As shown by reference number 545, the UE 120 may monitor for PDCCH communications during the period when the power-saving operational mode is disabled. In some aspects, the UE 120 may perform continuous or dense PDCCH monitoring during the period when power-saving modes are disabled. For example, the UE 120 may monitor the PDCCH continuously during the handover process or according to a relatively dense monitoring schedule. Additionally, or alternatively, the UE 120 may adjust a monitoring schedule to increase the frequency at which the UE 120 monitors for PDCCH communications during this period. For example, the UE 120 may increase the frequency of PDCCH monitoring during the handover compared to during power-saving operations. Additionally, or alternatively, during the period of the disabled power-saving operational mode, the UE 120 may perform dense PDCCH monitoring, increasing the likelihood of successfully received network commands. For example, the UE 120 may perform dense PDCCH monitoring to monitor for important network commands, which may help the UE 120 maintain a more consistent level of responsivity during mobility procedures.

As shown by reference number 550, the UE 120 may enable the power-saving operational mode after the completion of the handover procedure, the expiry of the timer, or the occurrence of the indicated quantity of power-saving operational mode cycles. In some aspects, after the handover procedure is complete, the timer expires, or the specified number of cycles is reached, the UE 120 may re-enable a power-saving mode of operation. For example, the UE 120 may re-enable C-DRX after the timer expires. Additionally, or alternatively, the UE may revert to a regular power-saving schedule, such as resuming C-DRX or other low-power states. For example, the UE 120 may resume a regular C-DRX schedule. Additionally, or alternatively, after the completion of the handover procedure, the UE 120 may re-enable the power-saving operational mode in accordance with a timer expiry or the predefined number of cycles. For example, the UE 120 may re-enable power-saving modes after the specified number of cycles have occurred, which may help the UE 120 returns to a power-efficient state once the handover process is complete. In some aspects, the UE 120 may enter a sleep mode during a period between receiving a physical downlink control channel message and communicating a data channel message.

As shown by reference number 555, the UE 120 may refrain from monitoring for PDCCH communications in association with operating according to the UE power-saving operational mode once re-enabled, which may help the UE to conserve battery power by implementing periods of scheduled inactivity. In some aspects, once the power-saving modes are re-enabled, the UE 120 may revert to sparse PDCCH monitoring, or monitoring for communications less frequently to conserve battery power. For example, the UE 120 may monitor the PDCCH less frequently to conserve battery power.

This approach balances the need for power conservation with maintaining essential network connectivity during periods of low activity associated with handover procedures. For example, the UE 120 may perform sparse PDCCH monitoring to balance power conservation with connectivity needs. Additionally, or alternatively, the UE 120 may adjust the monitoring schedule based on network conditions and application requirements, supporting performance and power efficiency. For example, the UE 120 may adjust the PDCCH monitoring schedule based on the current network conditions.

As indicated above, FIG. 5 is provided as an example. Other examples may differ from what is described with respect to FIG. 5.

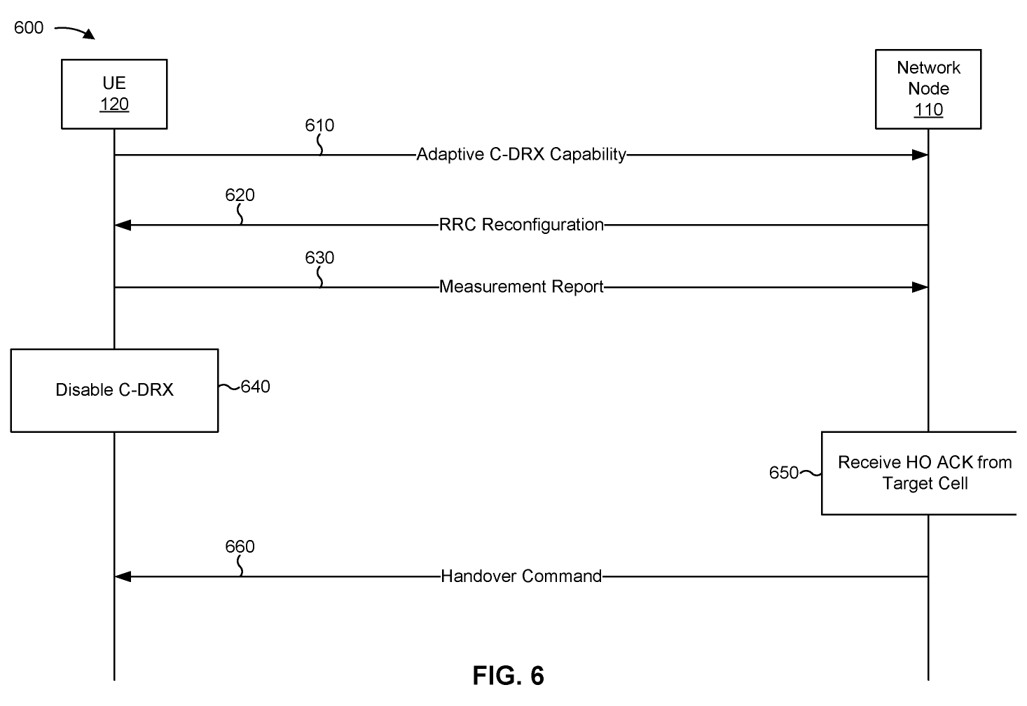

FIG. 6 is a diagram illustrating an example 600 associated with disabling C-DRX during handover procedures. As shown in FIG. 6, a network node 110 (e.g., a base station, a CU, a DU, or an RU) may communicate with a UE 120. In some aspects, the network node 110 and the UE 120 may be part of a wireless network (e.g., the wireless communication network 100). The UE 120 and the network node 110 may have established a wireless connection prior to operations shown in FIG. 6.

As shown by FIG. 6, and reference number 610, a UE 120 may transmit capability information indicating an adaptive C-DRX capability. For example, the UE 120 may transmit a capability message via an uplink communication, indicating whether the UE is capable of temporarily disabling a UE power-saving operational mode in association with (e.g., during, in response to, or in preparation for performing) a mobility procedure. In some aspects, the UE may send a capability message indicating a capability to temporarily disable power-saving modes during a mobility procedure, or a duration of time the UE is capable of temporarily disabling a power-saving mode of operation. For example, the UE 120 may transmit capability information indicating a capability to temporarily disable different power-saving modes such as C-DRX or PDCCH skipping during handover procedures. In some aspects, the capability message may indicate whether the UE 120 is capable of disabling modes like extended DRX, continuous DRX inactive, PDCCH skipping, or other power-saving modes during handover events. The UE 120 may transmit information about UE support for adaptive C-DRX capability and other power-saving modes during handover procedures, which may provide information to the network node 110 such that the network node may make decisions during mobility events according to capability information of the UE.

As shown by reference number 620, the network node 110 may transmit RRC reconfiguration message to the UE 120. For example, the network node 110 may provide the reconfiguration message indicating settings for different power-saving modes and the conditions under which they should be disabled. In some aspects, the network node 110 may send an RRC reconfiguration message to the UE 120, specifying conditions and time durations for disabling power-saving modes. The RRC reconfiguration may include parameters specifying the time duration or number of cycles for which the UE 120 should disable the power-saving operational mode. Additionally, or alternatively, the network node 110 may provide reconfiguration parameters for different power-saving modes such as extended DRX, continuous DRX inactive, and PDCCH skipping. The reconfiguration message may give the UE 120 the information needed to operate according to the network requirements during mobility events.

As shown by reference number 630, the UE 120 may transmit a measurement report to the network node 110. This report may include indications of conditions associated with the L1/L2 or L3 mobility event, such as cell conditions or radio frequency conditions. In some aspects, the UE 120 may send a measurement report to the network node 110, including details on cell conditions, radio frequency conditions, or other mobility event-related conditions. The measurement report assists the network node 110 in making informed handover decisions. Additionally, or alternatively, the measurement report may assist the network node 110 in making informed decisions for handover procedures. This may increase the likelihood that the network node 110 has the necessary information to manage the handover process effectively.

As indicated by reference number 640, the UE 120 may disable the C-DRX power-saving operational mode. For example, the UE 120 may refrain from entering a low power state, such as C-DRX, during the duration indicated by the network node 110 (e.g., with respect to transmitting the measurement report or with respect to an indicate delay with respect to transmitting the measurement report). In some aspects, the UE 120 may disable the C-DRX power-saving mode temporarily as indicated by the network node 110. Additionally, or alternatively, the UE 120 may refrain from entering other power-saving modes like extended DRX or PDCCH skipping during the specified duration.

As shown by reference number 650, the network node 110 may receive a handover acknowledgment (HO ACK) from the target cell. In some aspects, the network node 110 may receive the HO ACK from the target cell, confirming preparation for the UE 120 to switch over, which may indicate that the UE 120 may transition to the target cell.

Finally, as shown by reference number 660, the network node 110 may transmit a handover command to the UE 120. By the UE 120 receiving this command the handover process may be initiated and the UE 120 may switch from the source cell to the target cell without delays caused by missed messages during power-saving mode operations.

As indicated above, FIG. 6 is provided as an example. Other examples may differ from what is described with respect to FIG. 6.

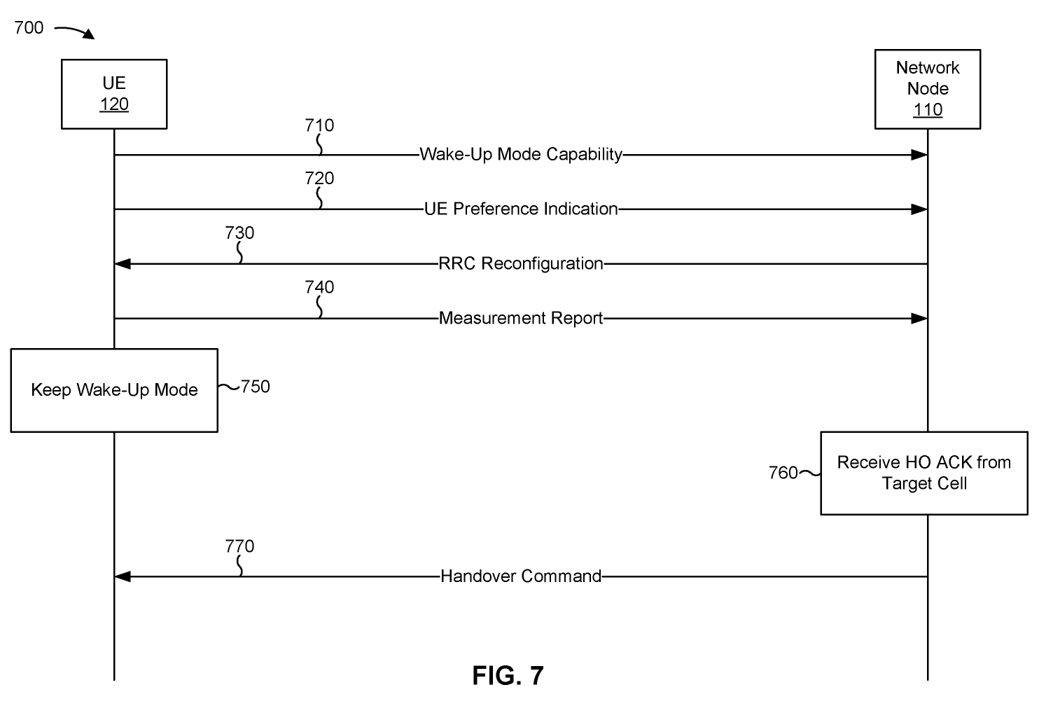

FIG. 7 is a diagram illustrating an example 700 associated with C-DRX wake mode operations during handover procedures. As shown in FIG. 7, a network node 110 (e.g., a base station, a CU, a DU, or an RU) may communicate with a UE 120. In some aspects, the network node 110 and the UE 120 may be part of a wireless network (e.g., the wireless communication network 100). The UE 120 and the network node 110 may have established a wireless connection prior to operations shown in FIG. 7.

As shown by reference number 710, the UE 120 may transmit capability information indicating support for adaptive C-DRX capability. For example, the UE 120 may transmit a capability message via an uplink communication, indicating whether the UE is capable of temporarily disabling a UE power-saving operational mode in association with a mobility procedure. In some aspects, the UE may send a capability message indicating a capability to temporarily disable power-saving modes during a mobility procedure. For example, the UE 120 may transmit capability information indicating a capability to temporarily extend wake cycles of a C-DRX mode of operation during handover procedures. Additionally, the capability message may specify whether the UE 120 is capable of disabling modes like extended DRX, continuous DRX inactive, PDCCH skipping, or other power-saving modes during handover events.

In some aspects, the UE 120 may transmit a capability message indicating a capability to manage power-saving modes during mobility events, such as handover procedures. For example, the UE 120 may indicate an adaptive C-DRX capability, or a capability for disabling or adjusting other power-saving modes during handover procedures. Additionally, or alternatively, the UE 120 may send an uplink communication to the network node 110, detailing which power-saving modes the UE 120 is capable of temporarily disabling during mobility procedures. For example, the capability message may specify the UE capability to disable power-saving modes like PDCCH skipping and sparse PDCCH monitoring during mobility events. This may increase the likelihood that the network node 110 is aware of the UE capabilities and may make appropriate decisions during mobility events.

For example, as shown by reference number 710, the UE 120 may indicate whether the UE supports an extended wake mode or whether the UE supports keeping wake mode activated during a mobility-triggered handover procedure.

As shown by reference number 720, the UE 120 may transmit, and the network node 110 may receive, a UE preference indication. For example, the UE 120 may transmit a preference indication to the network node 110. For example, the UE 120 may indicate a preference for disabling the power-saving operational mode, including the preferred duration based on application latency conditions or QoS parameters. For example, the UE preference indication may indicate a preferred time duration for extending or maintaining a UE wake mode based one or more application latency requirement. In some aspects, the UE 120 may send a preference message to the network node 110 indicating one or more power-saving mode settings based on current application needs or QoS requirements. For example, the UE 120 may indicate a preference to disable power-saving modes for HO procedures during high-latency applications such as video streaming. Additionally, or alternatively, the preference indication may include preferred durations for disabling power-saving modes to accommodate latency-sensitive applications. Additionally, or alternatively, the indication may also reflect preferences based on current serving cell conditions and predicted network performance during mobility events. For example, the UE 120 may indicate a preference to disable power-saving modes based on the signal strength of the serving cell. This allows the network node 110 to tailor the power-saving mode management according to the operating environment and service requirements of the UE. Additionally, or alternatively, the preference indication may include a preferred duration for disabling power-saving modes to accommodate latency-sensitive applications, such as video streaming or real-time gaming, to support performance while operating using such applications.

As shown by reference number 730, a network node 110 may transmit an RRC reconfiguration message to the UE 120. For example, the network node 110 may provide the reconfiguration message indicating settings for different power-saving modes and the conditions under which they should be disabled. In some aspects, the network node 110 may send an RRC reconfiguration message to the UE 120, specifying conditions and time durations for disabling power-saving modes or extending a wake cycle. The RRC reconfiguration may include parameters specifying the exact time duration or number of cycles for which the UE 120 should disable the power-saving operational mode or extend the wake cycle of a power-saving operation mode.

In some aspects, the network node 110 may transmit an RRC reconfiguration message to the UE 120, detailing conditions under which certain power-saving modes are to be disabled. For example, the reconfiguration message may specify the duration and conditions for disabling power-saving modes to support UE performance during mobility events. Additionally, or alternatively, the network node 110 may provide reconfiguration parameters for different power-saving modes such as extended DRX, continuous DRX inactive, and PDCCH skipping. For example, the network node 110 may provide an RRC message that outlines the exact cycles or time duration for which the UE 120 should keep the power-saving modes inactive. These reconfiguration messages may provide information to help the UE 120 operate according to the network requirements during mobility events.

Next, as shown by reference number 740, the UE 120 may transmit a measurement report to the network node 110. This report may include indications of conditions associated with the L1/L2 or L3 mobility event, such as cell conditions or radio frequency conditions. In some aspects, the UE 120 may send a measurement report to the network node 110, including details on cell conditions, radio frequency conditions, or other mobility event-related conditions. The measurement report assists the network node 110 in making informed handover decisions.

In some aspects, the UE 120 may send a measurement report to the network node 110, including data on cell conditions, radio frequency conditions, and other relevant factors associated with the L1/L2 or L3 mobility event. For example, the measurement report may help the network node 110 make informed decisions regarding handover procedures by providing detailed conditions. Additionally, or alternatively, the measurement report may assist the network node 110 in making informed decisions for handover procedures. For example, the UE 120 may transmit a measurement report indicating various conditions associated with the L1/L2 or L3 mobility event to help the network node manage the handover process, which may provide the network node 110 with information to manage the handover process effectively.

As indicated by reference number 750, the UE 120 may extend or maintain the wake-up operational mode. For example, the UE 120 may refrain from entering a low power state, such as a sleep cycle of C-DRX, during the duration indicated by the network node 110. In some aspects, the UE 120 may disable the power-saving mode temporarily as indicated by the network node 110, increasing the likelihood of successful communications during mobility events. For example, the UE 120 may extend the wake-up temporarily.

As shown by reference number 760, the network node 110 may receive a HO ACK from the target cell, which may confirm that the target cell is prepared for UE handover. In some aspects, the network node 110 may receive the HO ACK from the target cell, confirming preparation for the UE 120 to switch over.

As shown by reference number 770, the network node 110 may transmit, and the UE 120 (e.g., operating according to the disabled power-saving mode or the extended wake mode of C-DRX) may receive a handover command, which may initiate the handover process, allowing the UE 120 to switch from the source cell to the target cell without delays caused by missed communications caused by power-saving mode operations. In some aspects, the network node 110 may send a handover command to the UE 120, initiating the handover process and allowing the UE to switch from the source cell to the target cell.

As indicated above, FIG. 7 is provided as an example. Other examples may differ from what is described with respect to FIG. 7.

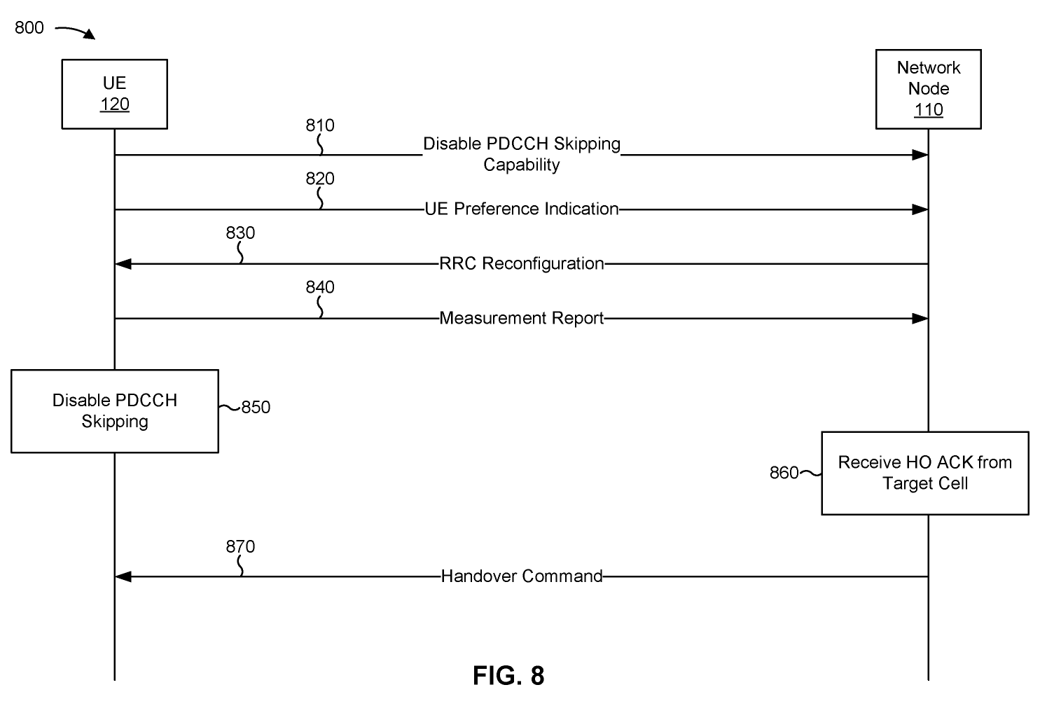

FIG. 8 is a diagram illustrating an example 800 associated with disabling PDCCH skipping during handover procedures. As shown in FIG. 8, a network node 110 (e.g., a base station, a CU, a DU, or an RU) may communicate with a UE 120. In some aspects, the network node 110 and the UE 120 may be part of a wireless network (e.g., the wireless communication network 100). The UE 120 and the network node 110 may have established a wireless connection prior to operations shown in FIG. 8.

As shown by FIG. 8, and reference number 810, a UE 120 may transmit capability information indicating support for disabling PDCCH skipping. For example, the UE 120 may transmit a capability message via an uplink communication, indicating whether the UE is capable of temporarily disabling a UE power-saving operational mode in association with a mobility procedure. In some aspects, the UE 120 may transmit a capability message indicating a capability to temporarily disable power-saving modes during a mobility procedure. For example, the UE 120 may indicate a capability to disable PDCCH skipping during handover procedures. Additionally, or alternatively, the capability message may specify whether the UE 120 may disable modes such as extended DRX, continuous DRX inactive, or other power-saving modes during handover events. For example, the UE 120 may indicate a capability to disable these modes to maintain connectivity during mobility events. Additionally, or alternatively, the UE 120 may indicate a capability to disable power-saving modes temporarily to maintain connectivity during mobility events. This may increase the likelihood that the UE remains receptive and responsive during mobility events.

As shown by reference number 820, the UE 120 may transmit a preference indication to the network node 110. For example, the UE 120 may indicate a preference for disabling the power-saving operational mode, including the preferred duration based on application latency conditions or QoS parameters. In some aspects, the UE 120 may send a preference message to the network node 110 indicating one or more power-saving mode settings based on current application needs or QoS requirements. For example, the UE 120 may indicate a preference to disable power-saving modes during high-latency applications such as video streaming. Additionally, or alternatively, the preference indication may include preferred durations for disabling power-saving modes to accommodate latency-sensitive applications. Additionally, or alternatively, the indication may also reflect preferences based on current serving cell conditions and predicted network performance during mobility events. For example, the UE 120 may indicate a preference to disable power-saving modes based on the signal strength of the serving cell. This allows the network node 110 to tailor the power-saving mode management according to the UE operating environment and service requirements. Additionally, or alternatively, the preference indication may include a preferred duration for disabling power-saving modes to accommodate latency-sensitive applications, such as video streaming or real-time gaming. This may increase the likelihood that the UE maintains optimal performance during such applications.

Next, as shown by reference number 830, the UE 120 may receive an RRC reconfiguration message from the network node 110. The RRC message may temporarily disable the UE power-saving operational mode in association with an L1/L2 or L3 mobility event that triggered an Handover procedure. In some aspects, the UE 120 may receive an RRC message from the network node 110, instructing the UE 120 to temporarily disable the power-saving mode in preparation for an imminent handover. For example, the RRC message may indicate that the UE 120 should disable PDCCH skipping during the handover process. Additionally, or alternatively, the RRC message may include details on the expected duration of the handover procedure and the specific power-saving modes to be disabled. For example, the message may specify that the handover is expected to take a certain duration of time, and the UE 120 is to disable PDCCH skipping during this time. Additionally, or alternatively, the RRC message received by the UE 120 may indicate an expected duration for performing the handover procedure with a target cell. For example, the RRC message may specify that the handover to the target cell is expected to take three minutes. This information helps the UE 120 remain responsive during the handover process. Additionally, or alternatively, the RRC message may specify the expected duration of the handover procedure and the specific power-saving modes to be disabled. This may increase the likelihood that the UE remains receptive during the handover period.

As shown by reference number 840, the UE 120 may transmit a mobility-event measurement report in response to receiving the RRC message. This report may include indications of conditions associated with the L1/L2 or L3 mobility event, such as cell conditions or radio frequency conditions. In some aspects, the UE 120 may send a detailed measurement report to the network node 110, including data on current cell conditions, signal strength, and radio frequency metrics. For example, the measurement report may include the signal strength of the current cell and the target cell. Additionally, or alternatively, the report may also include information on radio access technology conditions and other relevant parameters to assist the network node in making informed handover decisions. For example, the report may include details on the radio access technology being used and any interference metrics. Additionally, or alternatively, the UE 120 may include cell conditions, radio frequency conditions, and radio access technology conditions in the mobility-event measurement report. For example, the report may provide a comprehensive overview of the current cell conditions, including signal quality and interference levels. This comprehensive reporting assists the network node 110 in making informed decisions regarding the handover process. Additionally, or alternatively, the measurement report may include information on radio access technology conditions and other relevant parameters to assist the network node in making informed handover decisions. This may increase the likelihood that the network node has all necessary information to manage the handover efficiently.

Following the transmission of the measurement report, as indicated by reference number 850, the UE 120 may disable a PDCCH skipping power-saving operational mode. For example, the UE 120 may refrain from entering a low power state, such as PDCCH skipping, during the duration indicated by the network node 110. In some aspects, the UE 120 may disable the PDCCH skipping power-saving mode temporarily as indicated by the network node 110 or according to a preference or capability of the UE 120, which may support responsiveness of the UE 120 during mobility events. This may increase the likelihood that the UE remains responsive to network commands during mobility events. Additionally, or alternatively, the UE 120 may refrain from entering other power-saving modes like extended DRX or PDCCH skipping during the specified duration. This step may increase the likelihood that the UE 120 may maintain optimal performance and responsiveness during the handover process. Additionally, or alternatively, the UE 120 may disable the power-saving mode temporarily to support a smooth handover process without delays caused by power-saving modes. This may decrease the likelihood of interrupted connectivity during the handover or missed messages.

As further shown by reference number 860, the network node 110 may receive a HO ACK from the target cell. In some aspects, the network node 110 may receive a HO ACK from the target cell, confirming preparation for the UE 120 to switch over. This may increase the likelihood that the UE 120 may transition to the target cell without delays caused by missing one or more handover messages due to operations associated with a power-saving mode. Additionally, or alternatively, the network node 110 may receive confirmation that the target cell is prepared to accept the UE 120, supporting efficient handover.

As shown by reference number 870, the network node 110 may transmit a handover command to the UE 120. This command initiates the handover process, allowing the UE 120 to switch from the source cell to the target cell without delays caused by power-saving modes. In some aspects, the network node 110 may send a handover command to the UE 120, initiating the handover process and allowing the UE to switch from the source cell to the target cell. This may increase the likelihood a smooth transition by preventing power-saving modes from causing delays. Additionally, or alternatively, communicating the handover command with the UE 120 according to the disabled PDCCH skipping may initiate the switch to the target cell without delays caused by power-saving operations (e.g., suspended monitoring operations), supporting continuous connectivity. This step may increase the likelihood a smooth transition by preventing power-saving modes from incurring delays during the handover process.

As indicated above, FIG. 8 is provided as an example. Other examples may differ from what is described with respect to FIG. 8.

FIG. 9 is a diagram illustrating an example process 900 performed, for example, at a UE or an apparatus of a UE. Example process 900 is an example where the apparatus or the UE (e.g., UE 120) performs operations associated with adaptive power-saving operations for lower-layer triggered mobility procedures.

As shown in FIG. 9, in some aspects, process 900 may include transmitting a capability message that indicates whether the UE is capable of temporarily disabling one or more UE power-saving operational modes in accordance with a mobility procedure (block 910). For example, the UE (e.g., using transmission component 1104 or communication manager 1106, depicted in FIG. 11) may transmit a capability message that indicates whether the UE is capable of temporarily disabling one or more UE power-saving operational modes in accordance with a mobility procedure, as described above.

As further shown in FIG. 9, in some aspects, process 900 may include receiving, from a network node, a message that temporarily disables at least one UE power-saving operational mode of the one or more UE power-saving operational modes in accordance with an L1/L2 or L3 mobility event that triggered an Handover procedure (block 920). For example, the UE (e.g., using reception component 1102 or communication manager 1106, depicted in FIG. 11) may receive, from a network node, a message that temporarily disables at least one UE power-saving operational mode of the one or more UE power-saving operational modes in accordance with an L1/L2 or L3 mobility event that triggered an Handover procedure, as described above.

As further shown in FIG. 9, in some aspects, process 900 may include transmitting a mobility-event measurement report in accordance with receiving the message (block 930). For example, the UE (e.g., using transmission component 1104 or communication manager 1106, depicted in FIG. 11) may transmit a mobility-event measurement report in accordance with receiving the message, as described above.

As further shown in FIG. 9, in some aspects, process 900 may include disabling the at least one UE power-saving operational mode in accordance with transmitting the mobility-event measurement report (block 940). For example, the UE (e.g., using communication manager 1106, depicted in FIG. 11) may disable the at least one UE power-saving operational mode in accordance with transmitting the mobility-event measurement report, as described above.

Process 900 may include additional aspects, such as any single aspect or any combination of aspects described below or in connection with one or more other processes described elsewhere herein.

In a first aspect, process 900 includes initiating a timer after transmitting the mobility-event measurement report, wherein the timer is associated with a duration in which the at least one UE power-saving operational mode is disabled.

In a second aspect, alone or in combination with the first aspect, the duration includes a set of one or more discontinuous reception cycles of the at least one UE power-saving operational mode.

In a third aspect, alone or in combination with one or more of the first and second aspects, the at least one UE power-saving operational mode comprises at least one of a connected mode discontinuous reception (DRX) mode, an extended DRX mode, a continuous DRX inactive mode, a physical downlink control channel (PDCCH) skipping mode, a sparse PDCCH monitoring mode, a minimized grant-to-resource allocation gap mode, a disabled SSSG mode, UE light sleep mode, UE sleep mode, or a power-saving mode.

In a fourth aspect, alone or in combination with one or more of the first through third aspects, the capability message indicates a quantity of discontinuous reception cycles of the at least one UE power-saving operational mode that the UE is capable of disabling in response to the L1/L2 or L3 mobility event that triggered the Handover procedure.

In a fifth aspect, alone or in combination with one or more of the first through fourth aspects, the message includes at least one of a radio resource control message or a medium access control control element message, and indicates a duration for disabling the at least one UE power-saving operational mode.

In a sixth aspect, alone or in combination with one or more of the first through fifth aspects, disabling the at least one UE power-saving operation mode is triggered by at least one of a serving cell signal strength threshold or a serving cell signal quality threshold being satisfied.

In a seventh aspect, alone or in combination with one or more of the first through sixth aspects, the message indicates at least one of the serving cell signal strength threshold or the serving cell signal quality threshold.

In an eighth aspect, alone or in combination with one or more of the first through seventh aspects, process 900 includes the mobility-event measurement report includes an indication of one or more conditions associated with the L1/L2 or L3 mobility event, and the one or more conditions include at least one of one or more cell conditions associated with the L1/L2 or L3 mobility event, one or more radio frequency conditions associated with the L1/L2 or L3 mobility event, or one or more radio access technology conditions associated with the L1/L2 or L3 mobility event.

In a ninth aspect, alone or in combination with one or more of the first through eighth aspects, process 900 includes enabling the at least one UE power-saving operational mode after at least one of an Handover procedure completion, a timer expiry, or an indicated quantity of UE power-saving operational mode cycles have occurred.

In a tenth aspect, alone or in combination with one or more of the first through ninth aspects, the message indicates an expected duration for performing the Handover procedure with a target cell.

In an eleventh aspect, alone or in combination with one or more of the first through tenth aspects, process 900 includes transmitting a preference indication that indicates a UE preference for disabling the at least one UE power-saving operational mode.

In a twelfth aspect, alone or in combination with one or more of the first through eleventh aspects, process 900 includes transmitting a preference indication that indicates a duration for disabling the at least one UE power-saving operational mode in accordance with one or more application latency conditions.

In a thirteenth aspect, alone or in combination with one or more of the first through twelfth aspects, the one or more application latency conditions include one or more quality of service parameters.

In a fourteenth aspect, alone or in combination with one or more of the first through thirteenth aspects, the duration for disabling the at least one UE power-saving operational mode is associated with at least one of a serving cell signal strength or a serving cell signal quality.

In a fifteenth aspect, alone or in combination with one or more of the first through fourteenth aspects, process 900 includes predicting, using at least one of historical data or a machine learning algorithm, one or more parameters associated with at least one of application performance or the Handover procedure, wherein the duration is associated with the predicted one or more parameters.

In a sixteenth aspect, alone or in combination with one or more of the first through fifteenth aspects, process 900 includes refraining from monitoring for a physical downlink control channel in accordance with operating according to the at least one UE power-saving operational mode.

In a seventeenth aspect, alone or in combination with one or more of the first through sixteenth aspects, process 900 includes monitoring for a physical downlink control channel in accordance with temporarily disabling the at least one UE power-saving operational mode.

In an eighteenth aspect, alone or in combination with one or more of the first through seventeenth aspects, process 900 includes entering a sleep mode during a period between receiving a physical downlink control channel message and communicating a data channel message.

In a nineteenth aspect, alone or in combination with one or more of the first through eighteenth aspects, process 900 includes refraining from entering a sleep mode during a period between receiving a physical downlink control channel message and communicating a data channel message, in accordance with disabling the at least one UE power-saving operational mode.

In a twentieth aspect, alone or in combination with one or more of the first through nineteenth aspects, the at least one UE power-saving operational mode includes a schedule for physical downlink control channel monitoring, and the message temporarily switches the UE from monitoring according to a sparse monitoring schedule to monitoring according to a dense monitoring schedule.

In a twenty-first aspect, alone or in combination with one or more of the first through twentieth aspects, process 900 includes disabling the at least one UE power-saving operational mode in accordance with an expiry of a timer that is initiated in accordance with transmitting the mobility-event measurement report.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node. Example process 1000 is an example where the apparatus or the network node (e.g., network node 110) performs operations associated with adaptive power-saving operations for LTM procedures.

As shown in FIG. 10, in some aspects, process 1000 may include receiving a capability message that indicates whether a UE is capable of temporarily disabling one or more UE power-saving operational modes in association with a mobility procedure (block 1010). For example, the network node (e.g., using reception component 1202 or communication manager 1206, depicted in FIG. 12) may receive a capability message that indicates whether a UE is capable of temporarily disabling one or more UE power-saving operational modes in association with a mobility procedure, as described above.

As further shown in FIG. 10, in some aspects, process 1000 may include transmitting, to the UE, a message that temporarily disables at least one UE power-saving operational mode in accordance with a mobility event that triggered an Handover procedure (block 1020). For example, the network node (e.g., using transmission component 1204 or communication manager 1206, depicted in FIG. 12) may transmit, to the UE, a message that temporarily disables at least one UE power-saving operational mode in accordance with an L1/L2 or L3 mobility event that triggered an Handover procedure, as described above.

As further shown in FIG. 10, in some aspects, process 1000 may include receiving a mobility-event measurement report in response to transmitting the message (block 1030). For example, the network node (e.g., using reception component 1202 or communication manager 1206, depicted in FIG. 12) may receive a mobility-event measurement report in response to transmitting the message, as described above.

Process 1000 may include additional aspects, such as any single aspect or any combination of aspects described below or in connection with one or more other processes described elsewhere herein.

In a first aspect, the at least one UE power-saving operational mode is disabled for a duration that is relative to communication of the mobility-event measurement report.

In a second aspect, alone or in combination with the first aspect, the duration includes a set of one or more discontinuous reception cycles of the at least one UE power-saving operational mode.

In a third aspect, alone or in combination with one or more of the first and second aspects, the at least one UE power-saving operational mode comprises at least one of a connected mode discontinuous reception (DRX) mode, an extended DRX mode, a continuous DRX inactive mode, a physical downlink control channel (PDCCH) skipping mode, a sparse PDCCH monitoring mode, a minimized grant-to-resource allocation gap mode, a disabled SSSG mode, UE light sleep mode, UE sleep mode, or a power-saving mode.

In a fourth aspect, alone or in combination with one or more of the first through third aspects, the capability message indicates a quantity of discontinuous reception cycles of the at least one UE power-saving operational mode that the UE is capable of disabling in response to the L1/L2 or L3 mobility event that triggered the Handover procedure.

In a fifth aspect, alone or in combination with one or more of the first through fourth aspects, the message includes at least one of a radio resource control message or a medium access control control element message, and indicates a duration for disabling the at least one UE power-saving operational mode.

In a sixth aspect, alone or in combination with one or more of the first through fifth aspects, the at least one UE power-saving operational mode is disabled in accordance with at least one of a serving cell signal strength threshold or a serving cell signal quality threshold being satisfied.

In a seventh aspect, alone or in combination with one or more of the first through sixth aspects, the message indicates at least one of the serving cell signal strength threshold or the serving cell signal quality threshold.

In an eighth aspect, alone or in combination with one or more of the first through seventh aspects, process 1000 includes the mobility-event measurement report includes an indication of one or more conditions associated with the L1/L2 or L3 mobility event, and the one or more conditions include at least one of one or more cell conditions associated with the L1/L2 or L3 mobility event, one or more radio frequency conditions associated with the L1/L2 or L3 mobility event, or one or more radio access technology conditions associated with the L1/L2 or L3 mobility event.

In a ninth aspect, alone or in combination with one or more of the first through eighth aspects, the at least one UE power-saving operational mode is enabled after at least one of an Handover procedure completion, a timer expiry, or an indicated quantity of UE power-saving operational mode cycles have occurred.

In a tenth aspect, alone or in combination with one or more of the first through ninth aspects, the message indicates an expected duration for performing the Handover procedure with a target cell.

In an eleventh aspect, alone or in combination with one or more of the first through tenth aspects, process 1000 includes receiving a preference indication that indicates a UE preference for disabling the at least one UE power-saving operational mode.

In a twelfth aspect, alone or in combination with one or more of the first through eleventh aspects, process 1000 includes receiving a preference indication that indicates a duration for disabling the at least one UE power-saving operational mode in accordance with one or more application latency conditions.

In a thirteenth aspect, alone or in combination with one or more of the first through twelfth aspects, the one or more application latency conditions include one or more quality of service parameters.

In a fourteenth aspect, alone or in combination with one or more of the first through thirteenth aspects, the duration for disabling the at least one UE power-saving operational mode is associated with at least one of a serving cell signal strength or a serving cell signal quality.

In a fifteenth aspect, alone or in combination with one or more of the first through fourteenth aspects, the duration is associated with a set of one or more predicted parameters associated with at least one of application performance, or the Handover procedure.

In a sixteenth aspect, alone or in combination with one or more of the first through fifteenth aspects, the at least one UE power-saving operational mode includes a schedule for physical downlink control channel monitoring, and the message temporarily switches the UE from monitoring according to a sparse monitoring schedule to monitoring according to a dense monitoring schedule.

In a seventeenth aspect, alone or in combination with one or more of the first through sixteenth aspects, the at least one UE power-saving operational mode is disabled in accordance with an expiry of a timer that is initiated in accordance with transmitting the mobility-event measurement report.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be a UE, or a UE may include the apparatus 1100. In some aspects, the apparatus 1100 includes a reception component 1102, a transmission component 1104, or a communication manager 1106, which may be in communication with one another (for example, via one or more buses or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 140 described in connection with FIG. 1) of the UE.

In some aspects, the apparatus 1100 may be configured to perform one or more operations described herein in connection with FIGS. 5-8. Additionally, or alternatively, the apparatus 1100 may be configured to perform one or more processes described herein, such as process 900 of FIG. 9, or a combination thereof. In some aspects, the apparatus 1100 or one or more components shown in FIG. 11 may include one or more components of the UE described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the UE described above in connection with FIG. 1, such as a radio, one or more RF chains, one or more transceivers, or one or more modems, each of which may in turn be coupled with one or more antennas of the UE.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1104 may be co-located with the reception component 1102.

The communication manager 1106 may support operations of the reception component 1102 or the transmission component 1104. For example, the communication manager 1106 may receive information associated with configuring reception of communications by the reception component 1102 or transmission of communications by the transmission component 1104. Additionally, or alternatively, the communication manager 1106 may generate or provide control information to the reception component 1102 or the transmission component 1104 to control reception or transmission of communications.

The transmission component 1104 may transmit a capability message that indicates whether the UE is capable of temporarily disabling one or more UE power-saving operational modes in accordance with a mobility procedure. The reception component 1102 may receive, from a network node, a message that temporarily disables at least one UE power-saving operational mode of the one or more UE power-saving operational modes in accordance with an L1/L2 or L3 mobility event that triggered an Handover procedure. The transmission component 1104 may transmit a mobility-event measurement report in accordance with receiving the message. The communication manager 1106 may disable the at least one UE power-saving operational mode in accordance with transmitting the mobility-event measurement report.

The communication manager 1106 may initiate a timer after transmitting the mobility-event measurement report, wherein the timer is associated with a duration in which the at least one UE power-saving operational mode is disabled.

The communication manager 1106 may enable the at least one UE power-saving operational mode after at least one of an Handover procedure completion, a timer expiry, or an indicated quantity of UE power-saving operational mode cycles have occurred.

The transmission component 1104 may transmit a preference indication that indicates a UE preference for disabling the at least one UE power-saving operational mode.

The transmission component 1104 may transmit a preference indication that indicates a duration for disabling the at least one UE power-saving operational mode in accordance with one or more application latency conditions.

The communication manager 1106 may predict, using at least one of historical data or a machine learning algorithm, one or more parameters associated with at least one of application performance or the Handover procedure, wherein the duration is associated with the predicted one or more parameters.

The communication manager 1106 may refrain from monitoring for a physical downlink control channel in accordance with operating according to the at least one UE power-saving operational mode.

The communication manager 1106 may monitor for a physical downlink control channel in accordance with temporarily disabling the at least one UE power-saving operational mode.

The communication manager 1106 may enter a sleep mode during a period between receiving a physical downlink control channel message and communicating a data channel message.

The communication manager 1106 may refrain from entering a sleep mode during a period between receiving a physical downlink control channel message and communicating a data channel message, in accordance with disabling the at least one UE power-saving operational mode.

The communication manager 1106 may disable the at least one UE power-saving operational mode in accordance with an expiry of a timer that is initiated in accordance with transmitting the mobility-event measurement report.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication. The apparatus 1200 may be a network node, or a network node may include the apparatus 1200. In some aspects, the apparatus 1200 includes a reception component 1202, a transmission component 1204, or a communication manager 1206, which may be in communication with one another (for example, via one or more buses or one or more other components). In some aspects, the communication manager 1206 is the communication manager 155 described in connection with FIG. 1. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 145 described in connection with FIG. 1) of the network node.

In some aspects, the apparatus 1200 may be configured to perform one or more operations described herein in connection with FIGS. 5-8. Additionally, or alternatively, the apparatus 1200 may be configured to perform one or more processes described herein, such as process 1000 of FIG. 10, or a combination thereof. In some aspects, the apparatus 1200 or one or more components shown in FIG. 12 may include one or more components of the network node described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the network node described above in connection with FIG. 1, such as a radio, one or more RF chains, one or more transceivers, or one or more modems, each of which may in turn be coupled with one or more antennas of the network node. In some aspects, the reception component 1202 or the transmission component 1204 may include or may be included in a network interface. The network interface may be configured to obtain or output signals for the apparatus 1200 via one or more communications links, such as a backhaul link, a midhaul link, or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1204 may be co-located with the reception component 1202.

The communication manager 1206 may support operations of the reception component 1202 or the transmission component 1204. For example, the communication manager 1206 may receive information associated with configuring reception of communications by the reception component 1202 or transmission of communications by the transmission component 1204. Additionally, or alternatively, the communication manager 1206 may generate or provide control information to the reception component 1202 or the transmission component 1204 to control reception or transmission of communications.

The reception component 1202 may receive a capability message that indicates whether a UE is capable of temporarily disabling one or more UE power-saving operational modes in accordance with a mobility procedure. The transmission component 1204 may transmit, to the UE, a message that temporarily disables at least one UE power-saving operational mode of the one or more UE power-saving operational modes in accordance with an L1/L2 or L3 mobility event that triggered an Handover procedure. The reception component 1202 may receive a mobility-event measurement report in accordance with transmitting the message.

The reception component 1202 may receive a preference indication that indicates a UE preference for disabling the at least one UE power-saving operational mode.

The reception component 1202 may receive a preference indication that indicates a duration for disabling the at least one UE power-saving operational mode in accordance with one or more application latency conditions.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: transmitting a capability message that indicates whether the UE is capable of temporarily disabling one or more UE power-saving operational modes in accordance with a mobility procedure; receiving, from a network node, a message that temporarily disables at least one UE power-saving operational mode of the one or more UE power-saving operational modes in accordance with a Layer 1/Layer 2 or a Layer 3 mobility event that triggered a handover procedure; transmitting a mobility-event measurement report in accordance with receiving the message; and disabling the at least one UE power-saving operational mode in accordance with transmitting the mobility-event measurement report.

Aspect 2: The method of Aspect 1, further comprising: initiating a timer after transmitting the mobility-event measurement report, wherein the timer is associated with a duration in which the at least one UE power-saving operational mode is disabled.

Aspect 3: The method of Aspect 2, wherein the duration includes a set of one or more discontinuous reception cycles of the at least one UE power-saving operational mode.

Aspect 4: The method of any of Aspects 1-3, wherein the at least one UE power-saving operational mode comprises at least one of a connected mode discontinuous reception (DRX) mode, an extended DRX mode, a continuous DRX inactive mode, a physical downlink control channel (PDCCH) skipping mode, a sparse PDCCH monitoring mode, a minimized grant-to-resource allocation gap mode, a disabled search space switching group (SSSG) mode, UE light sleep mode, UE sleep mode, or a power-saving mode.

Aspect 5: The method of any of Aspects 1-4, wherein the capability message indicates a quantity of discontinuous reception cycles of the at least one UE power-saving operational mode that the UE is capable of disabling in response to the L1/L2 or L3 mobility event that triggered the Handover procedure.

Aspect 6: The method of any of Aspects 1-5, wherein the message includes at least one of a radio resource control message or a medium access control control element message, and indicates a duration for disabling the at least one UE power-saving operational mode.

Aspect 7: The method of any of Aspects 1-6, wherein disabling the at least one UE power-saving operation mode is triggered by at least one of a serving cell signal strength threshold or a serving cell signal quality threshold being satisfied.

Aspect 8: The method of Aspect 7, wherein the message indicates at least one of the serving cell signal strength threshold or the serving cell signal quality threshold.

Aspect 9: The method of any of Aspects 1-8, wherein: the mobility-event measurement report includes an indication of one or more conditions associated with the L1/L2 or L3 mobility event, and the one or more conditions include at least one of: one or more cell conditions associated with the L1/L2 or L3 mobility event, one or more radio frequency conditions associated with the L1/L2 or L3 mobility event, or one or more radio access technology conditions associated with the L1/L2 or L3 mobility event.

Aspect 10: The method of any of Aspects 1-9, further comprising: enabling the at least one UE power-saving operational mode after at least one of: an Handover procedure completion, a timer expiry, or an indicated quantity of UE power-saving operational mode cycles have occurred.

Aspect 11: The method of any of Aspects 1-10, wherein the message indicates an expected duration for performing the Handover procedure with a target cell.

Aspect 12: The method of any of Aspects 1-11, further comprising: transmitting a preference indication that indicates a UE preference for disabling the at least one UE power-saving operational mode.

Aspect 13: The method of any of Aspects 1-12, further comprising: transmitting a preference indication that indicates a duration for disabling the at least one UE power-saving operational mode in accordance with one or more application latency conditions.

Aspect 14: The method of Aspect 13, wherein the one or more application latency conditions include one or more quality of service parameters.

Aspect 15: The method of any of Aspects 13-14, wherein the duration for disabling the at least one UE power-saving operational mode is associated with at least one of a serving cell signal strength or a serving cell signal quality.

Aspect 16: The method of any of Aspects 13-15, further comprising: predicting, using at least one of historical data or a machine learning algorithm, one or more parameters associated with at least one of application performance or the Handover procedure, wherein the duration is associated with the predicted one or more parameters.

Aspect 17: The method of any of Aspects 1-16, further comprising: refraining from monitoring for a physical downlink control channel in accordance with operating according to the at least one UE power-saving operational mode.

Aspect 18: The method of any of Aspects 1-17, further comprising: monitoring for a physical downlink control channel in accordance with temporarily disabling the at least one UE power-saving operational mode.

Aspect 19: The method of any of Aspects 1-18, further comprising: entering a sleep mode during a period between receiving a physical downlink control channel message and communicating a data channel message.

Aspect 20: The method of any of Aspects 1-19, further comprising: refraining from entering a sleep mode during a period between receiving a physical downlink control channel message and communicating a data channel message, in accordance with disabling the at least one UE power-saving operational mode.

Aspect 21: The method of any of Aspects 1-20, wherein the at least one UE power-saving operational mode includes a schedule for physical downlink control channel monitoring, and the message temporarily switches the UE from monitoring according to a sparse monitoring schedule to monitoring according to a dense monitoring schedule.

Aspect 22: The method of any of Aspects 1-21, further comprising: disabling the at least one UE power-saving operational mode in accordance with an expiry of a timer that is initiated in accordance with transmitting the mobility-event measurement report.

Aspect 23: A method of wireless communication performed by a network node, comprising: receiving a capability message that indicates whether a user equipment (UE) is capable of temporarily disabling one or more UE power-saving operational modes in accordance with a mobility procedure; transmitting, to the UE, a message that temporarily disables at least one UE power-saving operational mode of the one or more UE power-saving operational modes in accordance with a Layer 1/Layer 2 or a Layer 3 mobility event that triggered a handover procedure; and receiving a mobility-event measurement report in accordance with transmitting the message.

Aspect 24: The method of Aspect 23, wherein the at least one UE power-saving operational mode is disabled for a duration that is relative to communication of the mobility-event measurement report.

Aspect 25: The method of Aspect 24, wherein the duration includes a set of one or more discontinuous reception cycles of the at least one UE power-saving operational mode.

Aspect 26: The method of any of Aspects 23-25, wherein the at least one UE power-saving operational mode comprises at least one of a connected mode discontinuous reception (DRX) mode, an extended DRX mode, a continuous DRX inactive mode, a physical downlink control channel (PDCCH) skipping mode, a sparse PDCCH monitoring mode, a minimized grant-to-resource allocation gap mode, a disabled search space switching group (SSSG) mode, UE light sleep mode, UE sleep mode, or a power-saving mode.

Aspect 27: The method of any of Aspects 23-26, wherein the capability message indicates a quantity of discontinuous reception cycles of the at least one UE power-saving operational mode that the UE is capable of disabling in response to the L1/L2 or L3 mobility event that triggered the Handover procedure.

Aspect 28: The method of any of Aspects 23-27, wherein the message includes at least one of a radio resource control message or a medium access control control element message, and indicates a duration for disabling the at least one UE power-saving operational mode.

Aspect 29: The method of any of Aspects 23-28, wherein the at least one UE power-saving operational mode is disabled in accordance with at least one of a serving cell signal strength threshold or a serving cell signal quality threshold being satisfied.

Aspect 30: The method of Aspect 29, wherein the message indicates at least one of the serving cell signal strength threshold or the serving cell signal quality threshold.

Aspect 31: The method of any of Aspects 23-30, wherein: the mobility-event measurement report includes an indication of one or more conditions associated with the L1/L2 or L3 mobility event, and the one or more conditions include at least one of: one or more cell conditions associated with the L1/L2 or L3 mobility event, one or more radio frequency conditions associated with the L1/L2 or L3 mobility event, or one or more radio access technology conditions associated with the L1/L2 or L3 mobility event.

Aspect 32: The method of any of Aspects 23-31, wherein the at least one UE power-saving operational mode is enabled after at least one of: an Handover procedure completion, a timer expiry, or an indicated quantity of UE power-saving operational mode cycles have occurred.

Aspect 33: The method of any of Aspects 23-32, wherein the message indicates an expected duration for performing the Handover procedure with a target cell.

Aspect 34: The method of any of Aspects 23-33, further comprising: receiving a preference indication that indicates a UE preference for disabling the at least one UE power-saving operational mode.

Aspect 35: The method of any of Aspects 23-34, further comprising: receiving a preference indication that indicates a duration for disabling the at least one UE power-saving operational mode in accordance with one or more application latency conditions.

Aspect 36: The method of Aspect 35, wherein the one or more application latency conditions include one or more quality of service parameters.

Aspect 37: The method of any of Aspects 35-36, wherein the duration for disabling the at least one UE power-saving operational mode is associated with at least one of a serving cell signal strength or a serving cell signal quality.

Aspect 38: The method of any of Aspects 35-37, wherein the duration is associated with a set of one or more predicted parameters associated with at least one of application performance, or the Handover procedure.

Aspect 39: The method of any of Aspects 23-38, wherein the at least one UE power-saving operational mode includes a schedule for physical downlink control channel monitoring, and the message temporarily switches the UE from monitoring according to a sparse monitoring schedule to monitoring according to a dense monitoring schedule.

Aspect 40: The method of any of Aspects 23-39, wherein the at least one UE power-saving operational mode is disabled in accordance with an expiry of a timer that is initiated in accordance with transmitting the mobility-event measurement report.

Aspect 41: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-40.

Aspect 42: An apparatus for wireless communication at a device, the apparatus comprising one or more memories and one or more processors coupled to the one or more memories, the one or more processors configured to cause the device to perform the method of one or more of Aspects 1-40.

Aspect 43: An apparatus for wireless communication, the apparatus comprising at least one means for performing the method of one or more of Aspects 1-40.

Aspect 44: A non-transitory computer-readable medium storing code for wireless communication, the code comprising instructions executable by one or more processors to perform the method of one or more of Aspects 1-40.

Aspect 45: A non-transitory computer-readable medium storing a set of instructions for wireless communication, the set of instructions comprising one or more instructions that, when executed by one or more processors of a device, cause the device to perform the method of one or more of Aspects 1-40.

Aspect 46: A device for wireless communication, the device comprising a processing system that includes one or more processors and one or more memories coupled with the one or more processors, the processing system configured to cause the device to perform the method of one or more of Aspects 1-40.

Aspect 47: An apparatus for wireless communication at a device, the apparatus comprising one or more memories and one or more processors coupled to the one or more memories, the one or more processors individually or collectively configured to cause the device to perform the method of one or more of Aspects 1-40.

Aspect 48: A device comprising a processing system that includes one or more processors and one or more code-storing memories coupled with the one or more processors, the processing system configured to cause the device to perform the method of one or more of Aspects 1-40.

Aspect 49: A device comprising a processing system that includes processor circuitry and code-storing memory circuitry, the processing system configured to cause the device to perform the method of one or more of Aspects 1-40.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
transmit a capability message that indicates whether the UE is capable of temporarily disabling one or more UE power-saving operational modes in accordance with a mobility procedure;
receive, from a network node, a message that temporarily disables at least one UE power-saving operational mode of the one or more UE power-saving operational modes in accordance with a Layer 1/Layer 2 or a Layer 3 mobility event that triggered a handover procedure;
transmit a mobility-event measurement report in accordance with receiving the message; and
disable the at least one UE power-saving operational mode in accordance with transmitting the mobility-event measurement report.

2. The UE of claim 1, wherein the processing system is configured to cause the UE to:
enable the at least one UE power-saving operational mode after at least one of:
a handover procedure completion,
a timer expiry, or
an indicated quantity of UE power-saving operational mode cycles have occurred.

3. The UE of claim 1, wherein the processing system is configured to cause the UE to:
transmit a preference indication that indicates a UE preference for disabling the at least one UE power-saving operational mode.

4. The UE of claim 1, wherein the processing system is configured to cause the UE to:
transmit a preference indication that indicates a duration for disabling the at least one UE power-saving operational mode in accordance with one or more application latency conditions.

5. The UE of claim 4, wherein the duration for disabling the at least one UE power-saving operational mode is associated with at least one of a serving cell signal strength or a serving cell signal quality.

6. The UE of claim 4, wherein the processing system is configured to cause the UE to:
predict, using at least one of historical data or a machine learning algorithm, one or more parameters associated with at least one of application performance or the handover procedure, wherein the duration is associated with the predicted one or more parameters.

7. An apparatus for wireless communication, comprising:
means for transmitting a capability message that indicates whether a user equipment (UE) is capable of temporarily disabling one or more UE power-saving operational modes in accordance with a mobility procedure;
means for receiving, from a network node, a message that temporarily disables at least one UE power-saving operational mode of the one or more UE power-saving operational modes in accordance with a Layer 1/Layer 2 or a Layer 3 mobility event that triggered a handover procedure;
means for transmitting a mobility-event measurement report in accordance with receiving the message; and
means for disabling the at least one UE power-saving operational mode in accordance with transmitting the mobility-event measurement report.

8. The apparatus of claim 7, further comprising:
means for refraining from monitoring for a physical downlink control channel in accordance with operating according to the at least one UE power-saving operational mode.

9. The apparatus of claim 7, further comprising:
means for monitoring for a physical downlink control channel in accordance with temporarily disabling the at least one UE power-saving operational mode.

10. The apparatus of claim 7, further comprising:
means for entering a sleep mode during a period between receiving a physical downlink control channel message and communicating a data channel message.

11. The apparatus of claim 7, further comprising:
means for refraining from entering a sleep mode during a period between receiving a physical downlink control channel message and communicating a data channel message, in accordance with disabling the at least one UE power-saving operational mode.

12. The apparatus of claim 7, wherein the at least one UE power-saving operational mode includes a schedule for physical downlink control channel monitoring, and the message temporarily switches the UE from monitoring according to a sparse monitoring schedule to monitoring according to a dense monitoring schedule.

13. The apparatus of claim 7, further comprising:
means for disabling the at least one UE power-saving operational mode in accordance with an expiry of a timer that is initiated in accordance with transmitting the mobility-event measurement report.

14. A method of wireless communication performed by a user equipment (UE), comprising:
transmitting a capability message that indicates whether the UE is capable of temporarily disabling one or more UE power-saving operational modes in accordance with a mobility procedure;
receiving, from a network node, a message that temporarily disables at least one UE power-saving operational mode of the one or more UE power-saving operational modes in accordance with a Layer 1/Layer 2 or a Layer 3 mobility event that triggered a handover procedure;
transmitting a mobility-event measurement report in accordance with receiving the message; and
disabling the at least one UE power-saving operational mode in accordance with transmitting the mobility-event measurement report.

15. The method of claim 14, further comprising:
initiating a timer after transmitting the mobility-event measurement report, wherein the timer is associated with a duration in which the at least one UE power-saving operational mode is disabled.

16. The method of claim 15, wherein the duration includes a set of one or more discontinuous reception cycles of the at least one UE power-saving operational mode.

17. The method of claim 14, wherein the capability message indicates a quantity of discontinuous reception cycles of the at least one UE power-saving operational mode that the UE is capable of disabling in response to the L1/L2 or L3 mobility event that triggered the Handover procedure.

18. The method of claim 14, wherein the message includes at least one of a radio resource control message or a medium access control control element message, and indicates a duration for disabling the at least one UE power-saving operational mode.

19. The method of claim 14, wherein disabling the at least one UE power-saving operation mode is triggered by at least one of a serving cell signal strength threshold or a serving cell signal quality threshold being satisfied.

20. The method of claim 14, wherein:
the mobility-event measurement report includes an indication of one or more conditions associated with the L1/L2 or L3 mobility event, and
the one or more conditions include at least one of:
one or more cell conditions associated with the L1/L2 or L3 mobility event,
one or more radio frequency conditions associated with the L1/L2 or L3 mobility event, or
one or more radio access technology conditions associated with the L1/L2 or L3 mobility event.
